(19) United States
(12) Patent Application Publication
(10) Pub. No.: US 2003/0017310 A1
(43) Pub. Date: Jan. 23, 2003

(54) Apparatus and method for efficiently producing high quality laminating substrates using liquid laminates and a resulting laminated product thereof

(76) Inventor: Steve Young, Dallas, TX (US)

Correspondence Address: Rudolph J. Buchel, Jr., Jones, Day, Reavis & Pogue, 2727 N. Harwood Street, P.O. Box 660623, Dallas, TX, 75266-0623, US

(21) Appl. No.: 09/811,066

(22) Filed: Mar. 16, 2001

(51) Int. Cl. B32B 15/08; B32B 27/00; B32B 27/06; B32B 27/08; B32B 27/10; B32B 27/16; B05D 1/02; B05D 1/30; B05D 3/00; B05D 3/06; B05C 11/00; B05C 13/00

(52) U.S. Cl. 428/195; 428/213; 428/457; 428/480; 428/500; 428/537.5; 118/58; 118/620; 118/641; 34/236; 427/8; 427/9; 427/487; 427/508; 427/512; 427/532; 427/299; 427/314; 427/316; 427/322; 427/324; 427/331; 427/346; 427/372.2; 427/421; 427/541

(57) ABSTRACT

The present invention comprises a wicket conveyor for conveying a series of wickets through pre-curing, curing and post-curing sections of a curing system. The wicket conveyor forms a continuous loop, having a straight upper track portion, a straight lower track portion and a pair of curved end portions of track that adjoin each end of the straight upper and lower track potions. Each wicket is attached to the wicket conveyor track such that the plane of the wicket is oriented at a predetermined angle. B wicket picks up a horizontally oriented sheet and carries it toward the pre-curing section. The wicket and substrate sheet are reoriented in response to the contour of the conveyor, into a near vertical planar orientation. While in the near vertical orientation, liquid coatings on the surface of the sheet substrate move down the substrate sheet in “sheet flow,” thereby leaving a smooth coating surface prior to curing. Wickets and the substrate sheets riding the wickets are approximately parallel with one another and closely spaced in straight portions of the conveyor, such as the space during pre- and post-curing sections. Bs a wicket enters the curing section, it follows the contour of the track around the distil end of the conveyor. That wicket falls away from the next wicket on the track, thereby opening a gap between the adjacent wickets. Bt this point, both wickets and sheets are irradiated with UV rays, causing UV curable laminates to be cured on the front, rear and sides of the substrate sheets as well as all parts of the wicket conveyor and wickets. Prior to entering the post-curing section, the wicket and substrate sheet are once again reoriented into a near vertical planar orientation and approximately parallel with other wickets in the post-curing section. In the post-curing section, excess latent heat is disputed from the sheets. The sheets are then unloaded for subsequent processing.

### BACKGROUND OF THE INVENTION

1. Field of the Invention

The present invention relates generally to the field of printing and more particularly to laminating printed mediums. More particularly, the present invention relates to a system and method for optimizing floor-space footprint while achieving and obtaining high quality print curing results. Still more particularly, the present invention relates to a system and method for obtaining high quality lamination results using liquid laminates and a liquid laminated product resulting thereof. Further, even more particularly, the present invention relates to a system and method for obtaining high quality lamination results for thickly layered laminates using liquid laminate mediums and a liquid laminate product resulting thereof.

2. Description of Related Art

Within the printed medium arts, it is well understood that various lamination products may be applied to the surface of a substrate in order to protect the substrate from the environment and increase the joie de vivre of the graphic images thereon. The term “laminate” will be understood herewithin to describe a product applied to a substrate by a heat and/or pressure bonding process for the protection and appearance of a substrate and any graphic image layers adhered to the substrate. A “substrate” may be defined as any medium capable of receiving printed, engraved or graphical characters and/or images. Exemplary substrates include, but are not limited to, a wide range of flexible, as well as, rigid materials, such as cellulose and cotton-based pulp papers, cardboards and mattes, polyethylene (polythene), polypropylene (cast and oriented (OOP)), cellophane, co-extrusions PVC, other laminates, and laminated substrates, metallised film and polyester.

Presently, laminate products are typically available for use in two forms, film and liquid. Film laminating, or as they are more commonly referred to, “overlaminating”, involves applying a film overlaminate to a substrate. Overlamination gives users the ability to alter the surface texture of a substrate to suit the particular artistic requirements of the user while at the same time, providing protection for the substrate, e.g. against ultraviolet (UV) light, mechanical or chemical abuse. Overlaminate film products are generally available in two application varieties: cold overlaminating films and overlaminate films containing heat activatable adhesives. The application of either variety to a substrate involves using a device called a roller laminator for applying pressure to the film overlaminate. Certain overlaminates incorporate thermal bonding materials in the film overlaminate itself while others include a heat activatable adhesive layer adjacent to the film. Those overlaminates are bonded to a substrate surface with laminator devices that incorporate heated rollers, or “hot shoes”, for activating the thermal bonding materials. Overlaminates can easily be bonded to other overlaminates so a substrate can be fully encapsulated using film overlaminates and thereby fully protecting the substrate from environmental exposure. Whenever overlaminates are used for encapsulating, the roller laminator device is normally equipped with upper and lower application stations which allow for one step overlamination processing. While either type of roll laminator requires a capital expenditure by the user, generally cold-bonded applications are less expensive. Additionally, cold roll laminators use less floor space because floor space need not be devoted for cooling the laminated substrate prior to stacking and subsequent processing operations such as cutting and trimming operations. However, it is generally accepted in the art that thermally bonding film overlaminates that incorporate thermal bonding materials produce a more lasting laminated product than cold bonding film overlaminates.

Film overlaminates, in general, are of extremely high quality and consistently dependable because the engineering and production variables are strictly controlled at a film overlaminate production facility. Users of film overlaminate products realize consistent lamination results because the user's task is to merely bond the film to the substrate while laminate producers assume the responsibility for quality assurance of the film overlaminate laminate. As compared to liquid laminate products, film laminates are easier to apply thus, the operator need not attain the degree of proficiency necessary for liquid laminating. Additionally, the operator is freed from having to extensively develop specialized technical competence. Film overlaminating products are available in a myriad of widths, lengths, depths and surface textures, many of which come in regular and flame retardant grades. In the normal course of the art, film overlaminate products are available in sheets or rolls to readily accommodate applications requiring pre-cut film widths of up to fifth-five inches and roll lengths of three to five hundred feet. Film depth, as a general rule, varies with the application, but are commercially available in thicknesses of from less than one to fifteen mils. (thousandths of an inch).

The degree of luster attributed to an underlying graphics image is related to a variety of factors including the thickness of a laminate layer applied thereon. Therefore, for attaining higher degrees of luster, it is sometimes desirable to increase the depth of the laminate layer. Film overlaminates are available in specialty thicknesses for achieving higher degrees of luster, but often require special-purpose roll laminators for applying the film to a surface. Surface textures also have a direct effect on the degree of luster attributed to an underlying image hence, variations in the surface texture have a direct effect on the degree of luster exhibited by the image. Film laminate surface textures are normally available for matte, satin, and low, medium and high gloss appearances from clear, translucent or opaque films. Film overlaminates can also be etched, embossed and impregnated with holographic images to suit the user. Although film overlaminates are enormously versatile while being relatively technique insensitive, the film has several shortcomings. First is the permanence of the laminate. While the film itself remains fairly resistant to moisture, weathering and other effects of aging, the bonding layer is readily susceptible to moisture and other solvents in the environment that egress from the edge. Single side applications leave the edge of the bonding layer exposed to the atmosphere and open to attack from moisture, pollutants and other solvents. With time, the bonding layer becomes more vulnerable as the cumulative effects of the environment on the adhesive increase with age. Even the bonding layers in encapsulated applications are sometimes weakened by humidity in the air during the bonding process. Aside from permanence shortcomings, film overlaminates are very expensive, normally costing three to ten times that of comparable liquid laminate. Additionally, film overlaminates necessitate the purchase of specialty film laminators for bonding the film overlaminates to substrates.

A liquid laminate is a plastic or acrylic applied to a substrate as a liquid, then bonded and cured into a hard, glossy finish. Liquid laminates are sometime referred to as “UV coatings” because many types of liquid laminate react to ultraviolet radiation, thus a UV light source is necessary for bonding and curing these types of laminates.

Side-by-side comparisons between comparable applications of film and liquid laminates return mixed reviews from users, but both have the potential to increase the aesthetics of an underlying graphic image. A graphics image reflects ambient light back to an onlooker as opposed to a luminescent image, such as computer monitor or television, that is a source of primary light to an onlooker. Therefore, the aesthetics of an underlying graphic image is affected by the optical properties of each optical transmission medium between an onlooker and the primary light source (remember, ambient light must be transmitted through a laminate layer to an underlying image prior to being reflected off the image and back through the laminate). The optical properties of a medium cause individual light waves, or colors, to respond differently to other colors in the light spectrum. It is understood that the optical properties of a medium reflect and attenuate light attempting to pass through the medium. The magnitude of the reflectance and attenuation due to the optical properties of a medium varies for different colors (wavelengths of light). Some colors may pass through an optical medium relatively unaltered, while others may be the highly attenuated and still other colors may be reflected or bent by the optical properties associated with the medium. Optical mediums have different optical properties, one type medium being different from another, and therefore have differing effects on colors. In addition to the type of medium that light is being transmitted through, thickness and shape of optical mediums between the onlooker and the light source also affect the color. The thickness of an optical medium has an additive effect on the attenuation and reflection of colors while the shape of a medium's surface has a direct impact on the quantity of light emitted from the medium (surface interface itself attenuates and reflect light waves). The optical properties of clear mediums, such as laminates, sometimes allow certain color to pass through relatively unattenuated, while highly attenuating others. Additionally, some colors are reflected by the medium and other are transmitted though the medium. The intensity of some colors seem to be amplified when viewed through a clear medium because other colors, colors that an onlooker's brain expects, are highly attenuated. Thus, part of the visual effect is merely an optical illusion. However, the intensity of some colors may actually be amplified. Recall that certain colors may be reflected by the medium. Reflections occur on internal surfaces of the medium as well as external surfaces. Light that is trapped in the medium bounces around until it is completely attenuated, or until it reflects off an image color that will allow it to pass through the surface of the medium. Therefore, the intensity of colors reaching an onlooker is an aggregate result of direct reflections and of internal secondary and tertiary reflections that finally exit the medium. Light is attenuated during each reflection so thicker mediums tend to have greater amplification effects on color intensities because less internal reflections are necessary to exit the medium. The cumulative visual effect to an onlooker can be stunning deep colors and enhanced contrast that seem to pop the underlying image off of the page. The “image depth,” or simply, depth, greatly enhances the visual effect of an image for an onlooker and sometimes seems to give the underlying image a pseudo three-dimensional quality.

An added visual effect attributed to thicker transparent mediums with smooth surfaces, such as laminates, is that the optical medium gives the image a “wet” look. The appearance of water on the an underlying image is, of course, merely another optical illusion but is brought about by the high content of specular light reflecting from and transmitted through thicker mediums with smooth surfaces. The specular component of light is the bright, direct reflective light rays, like direct sunlight off of a chrome bumper. Specular reflectance generally refers to reflected light rays that tend to stay parallel to one another and are less scattered by the surface. Smoother surfaces reflect more specular component of reflected light than rougher surfaces. Rougher textured surface mediums tend to have a lower specular component of reflected light and a much higher diffuse component. In addition to the roughness of the surface layer, light scattering, or diffused light, can also be due to light being scattered from layers below the surface layer, especially layers not being parallel with the surface layer, such as particulate matter. Reflected light rays that tend to stay parallel to one another are less scattered and therefore have a higher specular light component. Thinner mediums and those with more irregular and rougher surface textures, internally reflect a greater amount of light, causing the resultant light rays to be less intense and not parallel with one another and more scattered. Additionally, some thin laminates adhere to the contour of the ink resulting in a less than smooth surface layer. The light emitted from these mediums tends to have a lower specular component and a much higher diffuse component. The diffuse component of light is the dull reflection of light like light reflected off a well-worn bowling ball. The three-dimensional character of a laminated image is sometimes referred to as “image depth” or simply “depth” and greatly enhances the visual effect of an image for an onlooker.

While film and liquid laminates may have similar optical qualities, liquid laminates can be applied as thinner application coats than film which give some onlookers the sense of a cleaner appearance than that of the thicker layer of film laminate. Additionally, due to the chemical makeup of liquid laminates, laminated products from liquid laminates resist yellowing longer than comparable, or even more expensive, laminated products using film laminates. Film laminates, such as polyester film laminates, are especially susceptible to the yellowing effects of aging. Laminating sheet products using liquid laminates usually does not require that the operator install special purpose equipment for the application of the liquid laminate. Liquid laminates can be applied using aerosol and airless jet sprayers that are normally used in modern print operations. Both the depth and pattern of liquid laminates are easily controlled using contemporary jet sprayers generally associated with printing operations. In addition to jet sprayers, an extremely popular method for applying liquid laminates is using a “screening” (sometimes known as a silk screening) process. Screening gives users the almost real-time capability to adjust the volume (depth) and pattern of the liquid laminate on a substrate using centuries-old technology.

Luster or gloss, related to image depth, is the measure of the specular reflectance of a laminate layer. Surface texture directly influences the reflective properties of an optical transmission medium and therefore, the degree of luster associated with the laminate. The level of gloss may be influenced by a number of processing factors including the type and quantity (depth) of laminate being applied, the type and quantity of agents or additives in the laminate, the application process, substrate surface (bonding surface), pre-curing temperature and time, and curing temperature and time, the ambient air temperature, humidity and the UV component of the ambient light. These factors cause variations in the level of gloss, which range from a completely smooth and mirrored surface to an irregularly textured or matted surface. Matting of the surface of the enamel layer may be easily accomplished by adding a matting agent to the glaze or by lowering the firing temperature.

The range of applications to which liquid laminates are suitable is rather narrow, but for those applications, liquid laminates are extremely cost effective. Liquid laminate processing is not vulnerable to some of the bonding problems that are inherent in the overlaminating process and lead to wasted product, such as the problems of trapped air, wrinkles or tunneling of a film laminate. In order to get a superior bonding result using film, thermal lamination requires an operator to pay simultaneous attention to exposure time, temperature and pressure. Pressure is invariably necessary for bonding film to printed substrates because of infinitesimal irregularities on the surface of the substrate and print. Pressure is unnecessary when using liquid laminates because the laminates flow into the surface of the print and chemically bond to the image as well as the substrate or the substrate's ink-receptive coating. This airtight liquid laminate seal is also good protection against external environmental contaminants and the harmful effects from moisture and oxygen contained therein. Liquid laminates do not delaminate or become flawed when rolled or folded because lamination resins are exceedingly flexible and resilient to repeated bending. As is the case when a graphics image is applied over a non-planar surface and when the graphic is stretched, the finish is hard enough to withstand abrasion and flexible enough to resist cracking and flaking.

### SUMMARY OF THE INVENTION

The present invention relates to a coating curing system which optimizes the floor-space footprint for the associated equipment while achieving high quality curing results, a method for using same and a laminated produce produced thereon. The curing system includes a wicket conveyor for conveying a series of wickets through pre-curing, curing and post-curing sections of the curing system. The wicket conveyor forms a continuous loop, having a straight upper track portion, a straight lower track portion and a pair of curved end portions of track that adjoin each end of the straight upper and lower track potions. One of the upper and lower track portions comprises the pre-curing section and the other of the upper and lower track portion comprises the post-curing section and one end portion comprises the curing section. Each wicket is attached to the wicket conveyor track such that the plane of the wicket is oriented at a predetermined angle to the tangent of track at the attachment point and remains at that angle during its conveyance around the wicket conveyor. A substrate sheet is presented to a wicket positioned at the opposite end portion of the wicket conveyor as the curing section, that wicket is in a substantially horizontal plane. As the wicket moves along the curved, end portion of track, the wicket picks up the horizontally oriented sheet and carries it toward the pre-curing section. Prior to entering the pre-curing section, the wicket and substrate sheet are reoriented in response to the contour of the conveyor, into a near vertical planar orientation (the absolute angle is not determinative, “near vertical” may be taken as within half of a radian of vertical). While in the near vertical orientation, liquid coatings on the surface of the sheet substrate move down the substrate sheet in “sheet flow,” thereby leaving a smooth coating surface prior to curing. Wickets and the substrate sheets riding the wickets are approximately parallel with one another and closely spaced in straight portions of the conveyor, such as the space during pre- and post-curing sections. As a wicket enters the curing section, it follows the contour of the track around the distil end of the conveyor. That wicket falls away from the next wicket on the track, thereby opening a gap between the adjacent wickets. At this point, both wickets and sheets are irradiated with UV rays, causing UV curable laminates to be cured on the front, rear and sides of the substrate sheets as well as all parts of the wicket conveyor and wickets. Prior to entering the post-curing section, the wicket and substrate sheet are once again reoriented into a near vertical planar orientation and approximately parallel with other wickets in the post-curing section. In the post-curing section, excess latent heat is disputed from the sheets. The sheets are then unloaded for subsequent processing.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 is an illustration that represents a cut-away view of an exemplary laminated product wherein a graphics image is layered onto a substrate, which in turn is overlaid with a film laminate in accordance with the prior art;

FIG. 2 is an illustration that represents a cut-away view of an exemplary laminated product wherein a graphics image is layered onto a substrate, which in turn is overlaid with a liquid laminate in accordance with the prior art;

FIG. 3 is an illustration that represents a cut-away view of an exemplary laminated product similar to that depicted in FIG. 2 above, but showing a thicker depth of liquid laminate;

FIG. 4 is a representation of a cut-away view of a laminated product which depicts a graphics image layered onto a substrate, which in turn is overlaid by a liquid laminate in accordance with an exemplary embodiment of the present invention;

FIGS. 5A and 5B are diagrams of exemplary prior art liquid laminators used for laminating printed sheets in accordance with the prior art;

FIG. 6 is a diagram depicting a wicket used for conveying sheets along a wicket conveyor;

FIG. 7 is a diagram of a sheet curing system for curing liquid laminated sheet products in accordance with an exemplary embodiment of the present invention;

FIG. 8 is an illustration showing an oblique view of the space optimized sheet curing system depicted in FIG. 7 in accordance with an exemplary embodiment of the present invention;

FIG. 9 is a diagram depicting an enlarged oblique view of the pre-curing section and the post-curing section in accordance with exemplary embodiments of the present invention; and

FIG. 10 is a diagram depicting an enlarged oblique view of the curing section in accordance with an exemplary embodiment of the present invention.

### DETAILED DESCRIPTION OF THE INVENTION

It is well known in the graphic printing arts to provide a laminate layer over print medium and substrate which protects the medium and substrate from scratches and abrasions as well as waterproofing the print medium and substrate. Furthermore, a clear laminate layer also brings out the colors in a graphics image by presenting the viewer with a translucent lens from which to gain a perspective of the colored image. Lamination also increases the surface sheen or speculative reflectance from the surface which adds a degree of luster to the underlying image and gives the viewer with a sense of image depth. The optical properties associated with a laminate layer can also fool a viewer into interpreting pseudo three-dimensional properties from the image. Ambient light enters the surface of the laminate layer and is then reflected back toward the viewer from the underlying graphics image and back through the laminate's surface. The visual effect experienced by the viewer from the light reflected off the graphics image is predicated on how the optical properties of the laminate layer influence discrete wavelengths of the light. Discrete wavelengths of light can either be attenuated (filtered), reflected, attenuated and reflected or pass through the laminate layer unaltered. By understanding how the optical properties of a selected laminate relate to its attributes, an operator can select a laminate with attributes for applications that give a viewer a desired visual effect when viewing the underlying graphic image through the laminate layer. Laminate attributes to consider when selecting a laminate layer include the laminate type or its composition including agents, additives and contaminates, the tint or shade of the laminate, its thickness or depth and the surface texture of the laminate layer.

Film laminate manufacturers tightly control laminate attributes and therefore, they are nearly independent of operator technique. Thus, the overlaminating process itself does not vary from one laminate application to another, even where the separate laminate applications are intended for dissimilar visual effects. The overlaminating process, from the perspective of the operator, remains fairly constant. Achieving a matted, low luster visual effect with shallow, pale color reflections is operationally similar to achieving a glossy, high luster, three-dimensional visual effect with deep, rich color reflections.

While liquid laminate manufactures also tightly control the certain laminate attributes, such as composition, consistency, viscosity and the like, other attributes depend on the lamination process. Those laminate attributes are, therefore, highly dependent on operator technique. For example, if the operator desires a matted, low luster visual effect with shallow, pale color reflections, then a matting agent is added to the liquid laminate or the curing temperature is reduced to achieve the desired visual effect. However, achieving other visual effects have been heretofore unattainable because certain laminate layer attributes have been impossible to attain using liquid laminates in accordance with prior art liquid lamination processes. Applications requiring those visual effects, if attainable at all, were relegated to other lamination processes, such as overlaminating. However, even if some of these visual effects were possible, they went largely unrealized due to the prohibitive costs associated with the application processes.

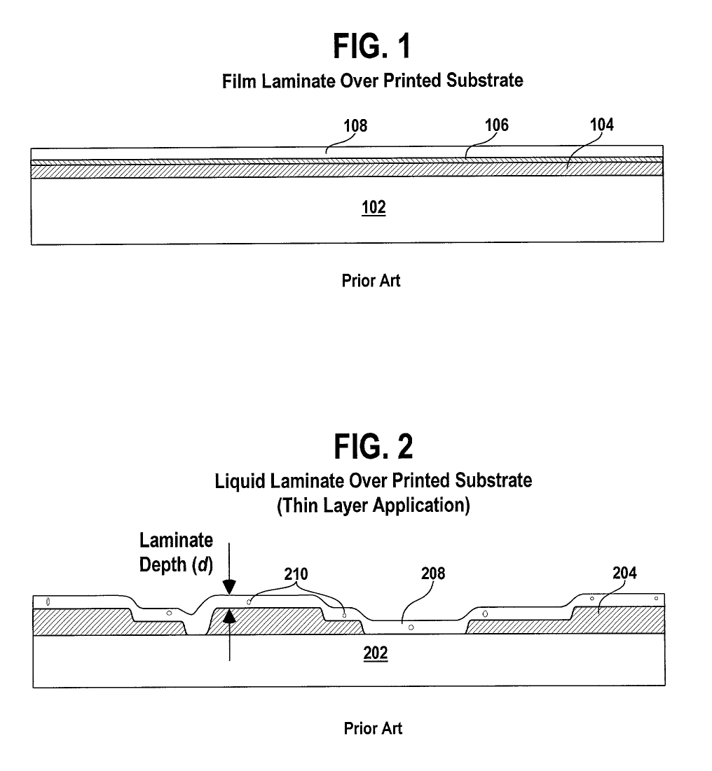

Such is the case for realizing a glossy, high luster, surface with three-dimensional visual effects in association with deep, rich color reflections from a laminated product derived from a liquid lamination process. This and other shortcomings of the prior art laminating processes will be discussed with respect to FIGS. 1-10.

FIGS. 1 through 4 are illustrations that represent cut-away views of exemplary laminated products wherein graphical images are layered onto a substrate which, in turn, is overlaid with at least one laminate layer. While each figure representation depicts each discrete layer extending the length of the figure representation, one of ordinary skill in the art will realize that the graphics image may not be continuous over the extent of the substrate layer or alternatively, may be omitted completely. Although the ordinary artisan will readily understand that the image medium may be characterized as something other than graphics, such as photographic, iconic, raster, text, etc., for the purposes herein, the print medium will be referred to as a graphics image. Alternatively, the graphics image may formed using an additional layer of substrate material bonded to the sheet substrate and fashioned into an image or text representation.

FIG. 1 is an illustration that represents cut-away view of an exemplary laminated product wherein a graphics image is layered onto a substrate which, in turn, is overlaid with a film laminate in accordance with the prior art. Here, substrate 102 may be flexible or rigid materials capable of receiving printed, engraved or graphical characters and/or images such as cellulose and cotton based pulp papers, cardboards and mattes, polyethylene (polythene), polypropylene (cast and OPP), cellophane, co-extrusions PVC, other laminates, and laminated substrates, metallised film and polyester, such as paper, cardboard or any other well-known bond, has been printed using any well-known printing technique such as silk screening, three color separation to N color separation off-set printing and the like. Often, substrate 102 is preprocessed by infusing the surface with an ink-receptive coating that facilitates bonding with the image medium. A popular coating for both cellulose and cotton fiber substrates is aluminum silicate, also known as “China Clay” or kaolin, but calcium carbonate and titanium dioxide are also used for bonding and to make them exceptionally smooth and allow a thinner, brighter layer of ink to be used thereon. China Clay may be coated on one side (C1S) or both sides (C2S) where high quality printing is desired on both sides to give a smoother, more even finish with greater opacity and to add “body” to individual sheets. Coated substrates such as (C1S) and (C2S) papers also facilitate bonding with other mediums such as laminate coatings. Layered on to the surface of substrate 102 is graphics image 104. Graphics image 104 may represent any type of graphics image wherein the graphics image is bonded to substrate 102 using any well known printing process. In an effort to protect graphics image 102 from being scratched or marred and from the harmful effects of the environment, graphic image 104 has been laminated using film laminate 108. As alluded to above, film lamination is readily understood as overlamination or overlaminating a substrate. In addition to protecting graphics image 104, overlamination alters the viewer's perception of the image and produces a visual effect on the viewer's perception of graphics image 104. A visual effect may vary from one type of overlamination application to another but for the purposes herein, the desired visual effect from lamination will be that of realizing graphics image 102 as having rich, vibrant colors and heightened contrast offering crisp definition and distortion-free image perception. The laminate must have a high degree of luster with a sparkling sheen and a deep, polished look. Additionally, the level of luster must be such that a viewer perceives the image as having a deep, “wet,” glossy appearance.

While each of these visual effects is not necessarily quantifiable, the overall visual effect may quantified by defining specific laminate layer attributes, i.e. color, composition, additives, thickness and level of gloss. Of the five attributes mentioned, laminate thickness and level of gloss are of most concern of the present disclosure. Superior visual effects may be obtained from most overlaminate products with a clear, untinted appearance that do not utilize or have tinting or shading additives during manufacturing. Exemplary types of films include compositions of polyvinyl-chloride (PVC), polyester, polypropylene, vinyl or the like that are available from, for example, 3M Product Center, 3M Center, Building 304-1-01, St. Paul, Minn. 55144-1000 U.S.A.

As mentioned above and of concern herewith, for achieving the high level of luster necessary for giving the image a deep, wet, glossy appearance are laminate thickness and the level of gloss produced by the laminate. Depending on this type of film, for best results, a film thickness of between 2.1 mils. and 10.5 mils. (0.0533 mm and 0.267 mm) is necessary, but rigid film laminate products commonly exceed thicknesses of 10.5 mil. Although the visual effects will vary with the type of composition of the film, generally, the most glossy, wet looking images are obtained from film laminate thicknesses in excess of 3.5 mil.

The luster or degree of luster is a slightly more abstract concept than thickness and therefore will be discussed in more detail. The luster or degree of luster or gloss is measured as standardized gloss units in accordance with American Society for Testing and Materials (ASTM), International Organization for Standardization (ISO) and Deutsches Institut fur Normung (DIN) standards and standardized testing. Gloss, or specular reflectance, is actually the measurement of light reflection off a surface, for instance light reflected from an overlaminate. A calibrated gloss meter is used to quantify how much light is actually reflected in standard gloss units. When light strikes the first surface of an object, a certain amount is reflected at an angle that is the equal, but opposite, to that of the incident light. Gloss is defined as the degree to which a finish of the surface approaches that of the theoretical specular gloss standard, or the perfect mirror, which is assigned a value of 1000. In practice, gloss measurements are made with reference to a black tile (actually a black or smoked glass that is used to calibrated each instrument) with a refractive index of 1.567 and assigned an arbitrary value of 100 gloss units. The black tile standard has a gloss finish, hence the value for gloss is set at 100 gloss units, conversely the value for matte finish is set lower, below 20 gloss units.

The amount of specular reflectance of the black glass at a given angle is dependent on the index of refraction of the glass. To determine the gloss level, the gloss meter shines a light source at a given angle measured from the perpendicular (vertical) to a surface. The specular intensity of the light source is known. A light receptor collects and measures the specular intensity of the reflected light at the same angle opposite the light source. By comparing the known specular intensity of the light with the specular intensity of the reflected light measured by the light receptor, a value for the index of refraction is calculated for the finish. However, the index of refraction must be calibrated to a known standard and scaled in gloss units, rather than an index value. The gloss meter is calibrated by generating a value for the black glass and referencing that value to the 100 gloss units standard for gloss (in practice the black glass is often set at 97.5 gloss units). Therefore, the value read from the display of a gloss meter is calibrated relative to the black glass standard. The geometry, or reference angle, of the gloss meter is normally dependent on the standardized test being preformed. For example, papermakers and printers use different reference angles to measure the level of gloss, papermakers measure gloss values at a 75° reference angle while printers measure gloss levels of conventionally printed paperboard at a 60° reference angle. The gloss value for some standardized tests for laminates may be read at 45° or 20° reference angles. However, with respect to laminated printed products, the printer's reference angle is used. Therefore, in accordance with the description of the present invention, the reference angle of the gloss meter geometry is set to 60°. Furthermore, the level of gloss necessary for a viewer to perceive the image as having a deep, “wet,” glossy appearance is a calibrated gloss level exceeding 97.0 gloss units plus or minus the accuracy of the gloss meter.

Thus, the gloss level attribute for a laminate must exceed 97.0 gloss units when measured from a calibrated gloss meter configured with a 60° reference angle.

The ordinary artisan will readily understand that the gloss level attribute of 97.0 gloss units at a 60° reference angle is merely a reference for a gloss level value that is based on a prescribed gloss meter geometry. Corresponding reference values may be determined for a identical gloss level attribute from calibrated gloss meters configured at geometries other than 60°. Currently, popular brands of gloss meters are available with reference angles of 20°, 35°, 45°, 80° or 85° and other reference angles might also be available depending on the particular gloss meter. An equivalent gloss level attribute value can be derived from the reference gloss level attribute of 97.0 gloss units at a 60° reference angle for a gloss meter configured with any reference angle. However, with respect to the discussion herein, the gloss level measurement is obtained form a surface using a specular gloss meter configured with a reference angle of 60°. Exemplary instruments are available from, for example, BYK-Gardner, Rivers Park II, 9104 Guilford Road, Columbia, Md. 21046.

It should, however, be understood that the substrate or graphics image might affect the outcome of the gloss measurement. For example, metallic foil or metallic print media might produce an erroneously high measured gloss value. Therefore, the gloss measurement should be read from a portion of the substrate or graphics image as close to white as possible.

Film overlaminating is well known and described in more specificity above, but basically the process involves taking sheets or rolls of film laminate and bonding them to graphics image 104 as represented in FIG. 1 by film laminate 108. Bonding a film laminate to an image or substrate is readily accomplished by pressure and/or heat curing film laminate 108 directly to graphic image 104. In accordance with this prior art embodiment, heat activatable adhesives are contained within the overlaminating film. Alternatively, in accordance with another prior art embodiment, bonding might instead be attained through the use of an adhesive applied, by the manufacturer, to the underside of the film laminate. This type of overlaminating film contains heat activatable adhesives. FIG. 1 depicts the latter embodiment as adhesive layer 106, but the adhesive layer may be absent in the application using film laminates that are designed to bond directly to a graphics image without the use of adhesives (not shown). Film lamination typically involves using specialized equipment for overlaminating a graphics image (lamination equipment is generically known as a laminator). Film laminate is held as a roll or individual laminate sheets on a roller laminator and feed off onto substrate 102 containing graphics image 104. The film laminate sheets are positioned onto substrate 102 via guides or guide rollers and then, using a laminate roller (more than one may be present), pressure is applied to the laminate in order to bond film laminate 108 to graphic image 104 using the adhesive material in laminate layer 106. If, as is more common, the overlaminating film contains heat activatable adhesives, then the pressure roller(s) are heated in order to induce thermal bonding while film laminate 108 is compressed onto the surface of graphic image 104. Using a laminate roll for the process also involves cutting the laminate between the individually laminated sheets. In addition to applying radiant heat from the laminate roller, certain types of overlaminate material may require additional energy for curing using ultraviolet (UV) light or infrared lights (IR) and even more exotic energy sources such as microwave, electron beam (E-beam) and other beamed energy.

Film laminate has the advantage of being of consistently high quality as a film laminate is manufactured under the strict supervision of a laminate manufacturer. The film laminate itself is strong, resilient and quite resistant to abuse. In addition, the overlaminating process, although requiring a specialized roller laminator, is generally considered to be relatively easy to employ. The film laminate itself is quite tolerant of overlaminating techniques; however, the bonding may be affected by not carefully following the film manufacturer's instructions and may result in trapped air, wrinkles or tunneling of the film laminate. The physical roller laminator itself has a relatively small floor space footprint and therefore, does not require an excessive area of floor space. However, if a post-curing section is necessary for cooling, then the footprint for the laminator may be substantially larger. Finally, a variety of film laminates are available directly from the manufacturer in a range of compositions, surface textures, tints and thicknesses to fix a wide variety of laminating applications. Unlike liquid laminates where many laminate attributes are realized as part of the lamination process, specific film laminate attributes can be stipulated with the manufacturer.

Although film laminate has many advantages, it is also much more expensive than a comparable liquid laminate for many, if not most, lamination applications typically performed by a printer. For a similar thickness or depth of laminate, film laminate costs between three to eight times what liquid laminates normally cost. Furthermore, film laminates require specialized equipment that is not normally available in a printing facility. Thus, in order to film laminate graphic images, the enterprise has to invest in specialized lamination equipment for applying the film laminate. Still further, the film laminate layer, such as layer 108 shown in FIG. 1, does not bond to the image layer in the same manner as liquid laminates. Film laminates are compressed onto the graphics image and substrate by means of pressure rollers. The film remains very viscous throughout the curing process. A film laminate cannot seep into the minute niches and recesses of the image in the same manner as a liquid laminate. Film laminate products with externally applied adhesives have a different problem. Although it is more likely that the externally applied adhesive will percolate into more of the graphics and substrate than film laminates containing the adhesive, these film laminates are always separated from the graphic image by that adhesive layer. Over time, the adhesive layer is prone to breakdown and bond failures. In order to have the desired visual effect on its viewers while simultaneously protecting the image, the laminate must remain bonded to the image. If an adhesive layer is present, it must remain intact and bonded to both the image and the film laminate. However, with the passing of time and as a result of environmental contaminants such as oxygen, moisture and other solvents leaching in, the bond between the film and the image usually begins to breakdown the adhesive. Normally, these contaminates enter from the lateral edges, but in some applications, they may filter through the substrate and attack the bond. Corners begin to tear away and eventually new portions of bond are exposed to the harmful contaminates until finally, the corners and edges are frayed and the product loses overall visual effect and appeal. The prior art has solved this problem by encapsulating the substrate by overlaminating the upper and lower faces of the substrate. The film laminate can then bond to itself at the edges of the substrate. Yet, this adds an exorbitant cost factor to the overall product. Moreover, many products have graphics images only on a single side and for the side of the substrate without an image, the visual effects produced by the film laminate are superfluous and go unrealized.

Given the shortcomings of film laminates and the overlaminating process, artisans in the prior art have readily adopted liquid laminates for laminating graphic images. FIG. 2 is an illustration that represents a cut-away view of an exemplary laminated product wherein a graphics image is layered onto a substrate which, in turn, is overlaid with a liquid laminate in accordance with the prior art. Here, graphics image 204 has been applied to substrate 202 similarly as discussed above with respect to FIG. 1. However, rather than overlaminating the image, liquid laminate 208 is applied directly to the surface of graphic image 204 and substrate 202. Liquid laminate 208 is applied directly to graphics image 204 rather than having an adhesive layer interposed in-between, the direct application of liquid laminate to the graphic image permits the laminate layer to bond directly to the graphic image. Adhesion to substrate 202 and graphics image 204 is virtually instantaneous. Liquid laminate 208 flows into the surface of the print and chemically bonds to graphics image 204, as well as substrate 202 or the substrate's ink-receptive coating. Likewise, the liquid is more able to penetrate infinitesimal imperfections in the image and substrate since it is less viscous that the film (not shown). This is especially helpful for applications where the graphics images are neither homogeneous nor contiguous. Liquid laminates are apposite for filling in holes, cracks and crevices in the image medium and substrate, thereby increasing the bonding surface area and providing a more reliable bond than film laminates.

Nevertheless, prior art liquid lamination processes have serious limitations over the prior art film laminating processes. Aside from the obvious potential problems associated with preparing the liquid laminate and accurately incorporating agents and additives for a specific application, severe problems plagued the prior art associated with applying and curing liquid laminates. Applying a liquid laminate to a substrate usually involves contaminating the laminate, to some degree, with air bubbles and other foreign particulate matter. Air bubbles 210 are often introduced into the liquid laminate and present severe quality problems to certain laminate applications.

Liquid laminate is normally applied to a surface using either a spray applicator or a screen applicator. Both applicators are described in greater detail above, but for the purposes of the present invention, the specific type of applicator or process for applying the liquid laminate is unimportant and therefore does not limit the scope of the invention. The function of the present invention, as will be described below, is unaffected by the type of liquid laminate applicator therefore, the present invention envisions the use of prior art types laminate applicators, as well as types liquid laminate applicators unrealized by the prior art and unknown at the time of the present invention.

With regard to either type laminate applicator, air is introduced in the application process forming air bubbles 210 within liquid laminate 208. Air bubbles 210 do not pose a significant threat to protective qualities of the laminate layer because air bubbles 210 are small, compared to the laminate depth, (d), and suspended in liquid laminate 208. As can be imagined, the quantity of air bubbles 210 is directly proportional to the laminate depth d. Air bubbles have two detrimental symbiotic consequences to the visual effect imparted by liquid laminate 208. First, the suspended air bubbles increase the opacity of laminate layer 204 and thereby obstruct the light traveling to and from graphics image 204. Inherent in each air bubble are optical properties that differ from those optical properties intrinsic to liquid laminate 208 thus, the inclusion of air bubbles 210 alter the laminate layer attributes and therefore, the visual effect realized by a viewer. Bubbles and particulate matter degrade the visual effect by increasing the opacity of laminate layer 204 and decreasing the specular component of the reflected light (discussed in detail below). Second, air bubbles 210 contort the surface of liquid laminate 208 whenever air bubbles 210 are proximate to the surface.

As will be discussed below, normally, the liquid laminate is applied to the substrate with the substrate in an approximate horizontal plane. With respect to thinner depths, d, as depicted in FIG. 2, the surface of the laminate layer is formed very close to graphics image 204, substrate 202, and air bubbles 210. Therefore, the contour of the surface is, to some degree, dictated by the roughness of the underlying surface, either substrate 202 or graphics image 204. Other peaks can be formed in the surface of laminate 208 where air bubbles approach the surface, while valleys are created from air bubbles braking through the surface and exhausted into the atmosphere. However, the surface texture of thin depths d laminate layer 208 is relatively unaffected by air bubbles as the bubbles burst almost immediately and any remaining bubbles are relatively small in comparison to depth d. Thus, increasing the pre-curing time will not result in a corresponding increase on the visual effect for thinner laminate layer depths d, where d is a manufacturer's suggested range of 0.5 mils. and 2.0 mils. (0.0127 mm and 0.0508 mm) with an outside limit of 4.0 mil and 5.0 mils. (0.1016 mm and 0.127 mm), because the liquid laminate adheres to the contours of the substrate and graphics image almost immediately. The internal tension forces of the laminate are often much greater than the laminate's surface tension which attempts to keep the depth d approximately even across the graphics image, even when the thickness of the ink comprising graphics image 204 is uneven over substrate 202 as depicted in FIG. 2. Notice that the surface contour of liquid laminate layer 208 follows the contour of substrate 202 and graphics image 204, causing peaks and valleys to form in the surface of the laminate due to the uneven application of printing inks on the substrate. Few air bubbles are trapped in laminate layers of between 0.5 mils.-5.0 mils. (0.0127 mm-0.127 mm) due to the application of the laminates. Nevertheless, no amount of pre-curing time will perceptively alter the visual effect of a thin depth d laminates because neither the force of gravity, nor surface tension can overcome the internal surface tension created in the thin layer laminate—the contour of laminate layer 208 will replicate the underlying surface texture.

On the other hand, because any air bubbles 210 in laminate layer 208 that may alter the visual effect immediately burst and the remaining air bubbles are small enough not to diminish the visual effect. The laminate layer can be cured almost immediately after application with the liquid laminate. However, this is only possible for a laminate depth d of between 0.5 mils. and 5.0 mils. (0.0127 mm and 0.127 mm) which equates to an approximate laminate application rate of less than five pounds per hundred sheets (5 lbs. per 100) of a typical 24×40 in. sheet stock. Applications ratios vary, but a rule of thumb is 1 lbs. per 100 sheets of laminate for a laminate depth of 1.0 mil. on typical 24×40 in. sheet stock.

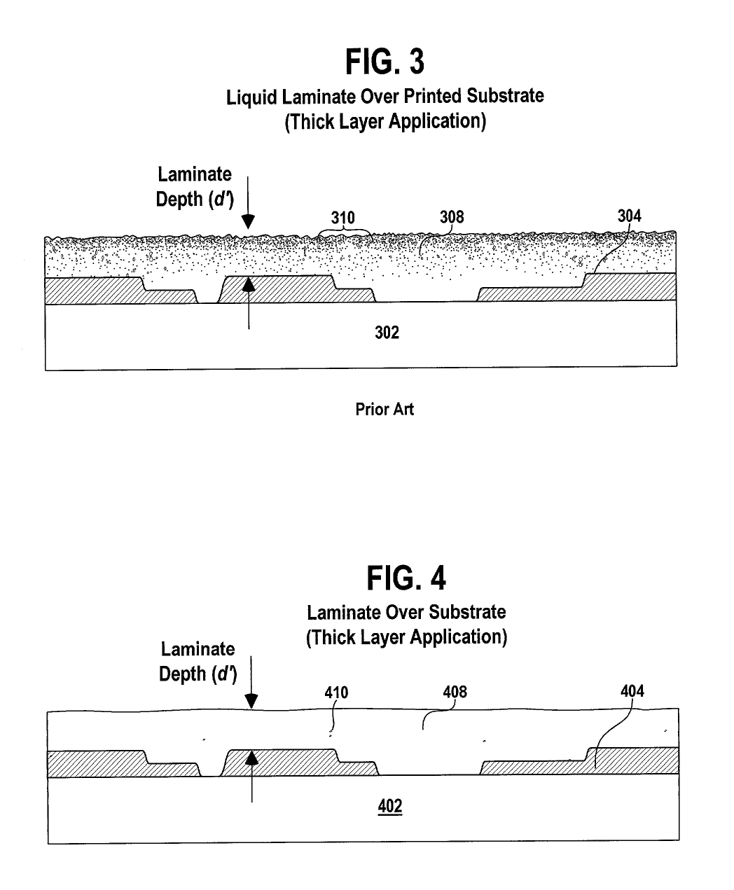

FIG. 3 is an illustration that represents a cut-away view of an exemplary laminated product similar to that depicted in FIG. 2 above, but showing a thicker liquid laminate. Here, similar to that described above, graphics image 304 is printed on substrate 302 and liquid laminate 308 is applied directly to the surface of graphic image 304 and substrate 302. The liquid laminate depth d′ is greater than depth d depicted in FIG. 2, resulting in a pair of problems not readily associated with thinner layer laminates including: 1) a corresponding increase in the quantity of air bubbles 310 trapped in the liquid laminate layer; and 2) minor surface imperfections (i.e. orange peel), attributable to the laminate application process, neither of which are easily smoothed over. Although the visual effects associated with thin laminates are, on occasion, noticeably degraded from trapped air bubbles and orange peel, these problems are more pervasive with thicker laminate layers.

The majority of air bubbles 310 shown in FIG. 3 have ascended in liquid laminate layer 308 to positions near or at the surface. The massive quantity of air bubbles have a detrimental affect on the overall visual effect obtained from liquid laminate 308 due to the inferior optical properties of air bubbles 310 which, among other things, scatter the light rays that pass through the laminate layer and increase its opacity. Notice also that the quantity of air bubbles 310 trapped near the surface of liquid laminate 308 have directly contributed to the degraded quantity and severity of surface irregularities hence, the visual effect is even further degrading for the viewer.

Laminates with thinly layered laminate, depth d, have surface imperfections that result from the proximity of the laminate's surface to the surfaces of the substrate and graphics image. On the other hand, the surface of thickly layered laminates, depth d′, is relatively unaffected by the surface contours of the substrate and graphics image but still, these surfaces do not have the high degree of luster necessary for a viewer to perceive the image as having a deep, “wet,” glossy appearance. Applying the liquid laminate is not a completely homogeneous process. The configuration of application mesh or jet nozzles never lay down a “mirror” smooth surface but instead, a surface that reflects the application pattern. These application patterns, orange peel, are sometimes very slight imperfections, resulting in a gloss level only ten or fifteen gloss (10 or 15) units less than a mirror finish (sometimes even less than ten gloss units).

Gravity and the natural surface tension of liquid laminate 308 must smooth over the peaks and fill in the valleys prior to curing liquid laminate 308. It could be assumed that given enough time, these surface irregularities and air bubbles could be excised from the laminate layer in a pre-curing process. The liquid laminate would merely “flow-out” the surface imperfections. During flow-out, gravity and the natural surface tension of liquid laminate 308 continually flows or migrates liquid into low spots on the surface created by air bubbles 310, or the like. Notice that because the depth d′ of laminate layer 308 is much thicker than depth d depicted in FIG. 2, and also that the contour of the surface of substrate 302 and graphics image 304 does not influence the surface texture of laminate layer 308. Therefore, gravity and surface tension forces could, conceivably, overcome the effects of the internal laminate layer forces on the surface of laminate layer 310.

The length of the pre-curing process is based on the migration speed, or speed in which the liquid laminate flows, and depends, for the most part, on the height disparity between adjacent high and low areas and on the viscosity of liquid laminate 304. Increased migration speeds can be achieved on more irregular surfaces, but pre-curing time is retarded because, even though faster migration speeds are achieved, the surface is more irregular and at some point, migration speed slows correspondingly with the surface roughness. At that point, the height disparity between adjacent high and low areas is much less and the laminate migration speed is reduced accordingly. This is the exact problem with application related surface imperfections such as orange peel The imperfections are severe enough to reduce the visual effect, but too small to generate any appreciable migration (flow-out) speed. The greater the disparity between adjacent high and low areas, the faster the initial migration speed but more time is necessary for pre-curing the laminate because the flow-out speed is gradually reduced, prior to the surface being completely smooth.

Decreasing the viscosity of the liquid laminate results in faster migration speeds throughout pre-curing, but has the drawback of reducing the laminate thickness across the laminate application area. Lower viscosities can cause the slurry of liquid laminate to become extremely mobile and run toward low spots on the sheet being laminated, thus uncured liquid laminate will tend to pool up in low areas. Pooling of low viscosity laminates is an especially serious drawback with less rigid substrates. Typical resultant prior art laminated products from lower viscosity laminates, while attaining somewhat smoothed, semi-glossy to glossy surfaces, have the visual effect of looking through a “fun-house mirror” because the laminate depth d varies from place to place on the sheet. The character of the graphics image is sometimes distorted and visual effect to the viewer degraded. Adjusting curing time and temperature was equally problematic because of the uneven laminate depths d across an individual sheet. Some portions of laminate with thinner depths were over-cured, while other portions with thicker laminate deeps, went under-cured. Therefore, prior art liquid laminate applications achieved only marginal success realizing a liquid laminate layer with attributes conducive for imparting to a viewer the effect of a high degree of luster with a sparkling sheen and a deep, polished look. The prior art processes were never able to produce a laminate layer with a high level of luster such that a viewer perceives the image as having a deep, “wet,” glossy appearance from a liquid laminate. In recognition that only a marginal result could be attained toward the desired visual effects described above, operators maintains the thickness of the laminate depth d to the manufacturer suggested range of 0.5 and 5.0 mils. (0.0127 mm-0.127 mm). These shortcomings can be better understood by describing a prior art liquid laminator and a process for using applying liquid laminates to a substrate therewith.

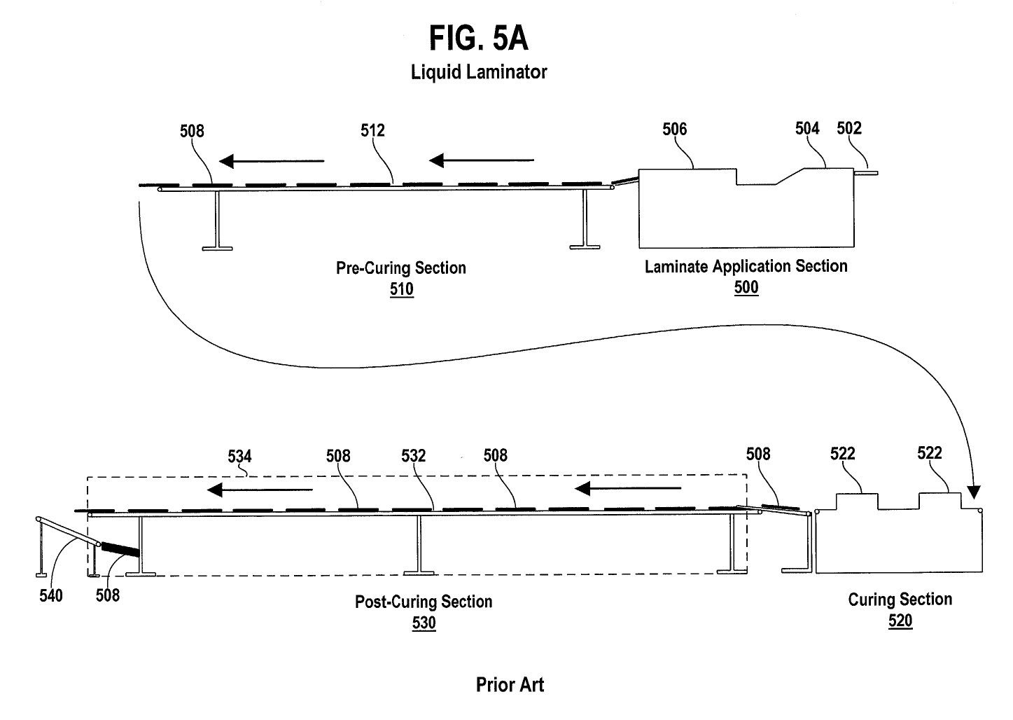

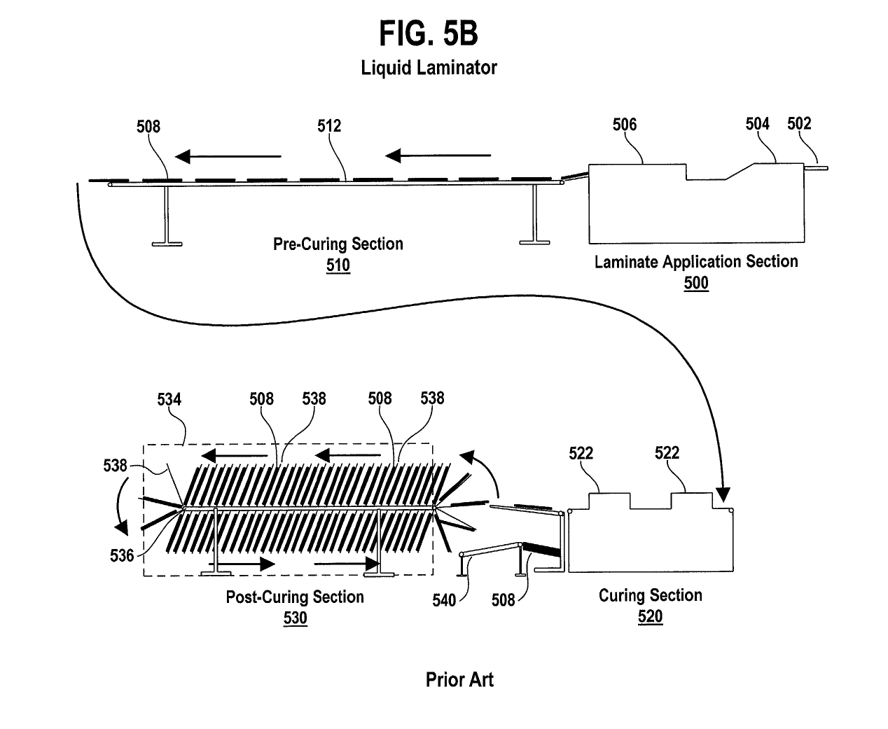

FIGS. 5A and 5B are diagrams of exemplary prior art liquid laminators used for laminating printed sheets in accordance with the prior art. Element numbers used to identify corresponding elements in FIGS. 5A and 5B are identical for corresponding elements between the figures. The exemplary laminators are comprised of four major processing sections: laminate application section 500 for applying the liquid laminate to the individual sheets; pre-curing section 510 for flowing-out the air bubbles and surface irregularities in the liquid laminate prior to curing the laminate; curing section 520 for UV curing the liquid laminate; and post-curing section 530 for cooling the laminated sheets prior to stacking and cutting.

Printed sheet 508 begins the lamination process positioned in a horizontal orientation in a stack of printed sheets at sheet feeder 502. Rollers at feeder board 504 grab the top sheet and pass it through to screen section 506 where a coat of liquid laminate is applied to sheet 508. Screen section 506 applies liquid laminate using a typical silk screen of the type employed by many printing facilities and which requires little or no adaptation for the application of liquid laminates. Once liquid laminate has been applied, sheet 508 exits laminate application section 500 and is fed onto conveyor 512 in pre-curing section 510. Sheets 508 are spaced along the horizontal track of conveyor 512 and each positioned in a horizontal plane approximately parallel with the direction of travel. As mentioned above, with respect to FIGS. 2 and 3, air bubbles and surface irregularities need time to flow out. Pre-cure conveyor 512 conveys each of sheets 508 between laminate application section 500 and curing section 520 in a predetermined amount time for pre-curing (flowing out) air bubbles and surface imperfections. The specific amount of pre-cure time may vary, slightly, between one laminate application and another but generally, pre-curing a laminate layer in accordance with the prior art takes less than five seconds for laminate depths of between 0.5 mils.-5.0 mils. (0.0127 mm-0.127 mm), although the time allotted for pre-curing maybe much longer, between five to fifteen seconds are possible. Pre-curing, according to the prior art, amounts to little more that giving the liquid laminate time to settle on the substrate. Adhesion to the substrate is immediate and the surface of the laminate layer is formed very close to the graphics image and substrate because depth d is very small. This is so, as described above, because the internal tension forces of the laminate are generally much higher than the laminate's surface tension thereby causing peaks and valleys in the surface of the laminate due to the uneven application of printing inks and the roughness of the substrate material. No amount of pre-curing time will allow gravitational or surface tension forces overcome the internal forces of the liquid laminate layer. Thus, surface texture of a prior art laminate layer is relatively unaffected by the amount of time allotted for pre-curing.

The liquid laminate remains in an uncured state as sheet 508 moves along pre-cure conveyor 512. There, sheet 508 remains oriented in a substantially horizontal plane, while gravitational and surface tensile forces produce the leveling effect that smoothes the surface of the laminate. These forces also cause the uncured laminate to flow towards the edges of sheet 508. Pre-curing requires a predetermined amount of time that depends on the lamination application. Thicker depths d′ take longer to pre-cure than thinner depths d (for the purpose herein, laminate depths d′ may be understood as any thickness greater than 5.0 mils. (0.127 mm). Similarly, higher viscosity laminates generally take longer to pre-cure than lower viscosity laminates. Therefore, the speed at which pre-cure conveyor 512 moves sheet 508 and the length of pre-cure conveyor 512 are crucial to proper pre-curing. Being a commercial operation, profitable of a laminating application depends upon sheets 508 rapidly exiting pre-cure conveyor 512. However, as speed increases, the length of pre-curing conveyor must be expanded less there be a reduction in pre-curing time thus, the floor space footprint of pre-curing section 510 increases proportionally to the increased speed of pre-cure conveyor 512.

Applying lower viscosity liquid laminates would seem to be a solution to longer pre-curing times, but as discussed above, lower viscosity liquid laminates produce a substandard laminated product for applications involving increased laminate depths d′. In addition, using lower viscosity liquid laminates increases wastage due to superfluous uncured laminate flowing off the lateral edges of sheet 508 and onto pre-cure conveyor 512. From there, the uncured laminate contaminates the downward facing surfaces of other sheets. The uncured liquid laminate causes a host of problems such as degrading and contaminating finished products, bonding multiple sheets together causing jams in subsequent operations, stacking, cutting, sorting, etc., all of which results in wasted product and higher operating costs.

Applying more viscous liquid laminates would seem to be a solution to the quality and contamination problems, but viscous liquid laminates require much longer pre-curing times for applications involving increased laminate depths d′ Shortening pre-curing times produce a laminated product that is similar to that illustrated in FIG. 3. The solution there seems to be slowing the speed of pre-cure conveyor 512 or increasing its length. Either solution is terribly expensive to implement and for the laminate depths d′ necessary for the desired visual effect are prohibitive. Aside from expense, thick liquid laminate depth d′ applications have a heretofore unresolved quality problem. Recall that gravity and the surface tension of the liquid laminate tend to smooth the surface of the liquid laminate. However, working against these forces is the internal tension of the liquid. The internal tensile forces increase with viscosity making pre-curing a much longer process. In practice, the forces of gravity and surface tension reach an equilibrium state with the internal forces of the liquid prior to the surface irregularities dissipating. The cured product, while generally free of trapped air bubbles, exhibits an irregular and rough, “orange peal” surface texture. The visual effect from such a product is a satin, low luster that is suggestive of an irregular matte texture. Glossy, high luster images are impossible to realize through such a surface texture. Therefore, prior art liquid laminating processes were limited to relatively thin laminate layer depth d of between 0.5 mils. and 5.0 mils. (0.0127 mm and 0.127 mm).

Returning to the description prior art laminating processed related to FIGS. 5A and 5B, once the thin liquid laminate is sufficiently pre-cured, that is, the trapped air bubbles reach the surface and the surface irregularities flow out, sheet 508 exits pre-curing section 510 and enters curing section 520 were the thin depth d liquid laminate is cured using UV lamps 522. Here, UV energy from UV lamps 522 beam down into the liquid laminate on sheet 508 as it passes under each of the banks of UV lights.

Exemplary UV lamps 522 are medium pressure mercury lamps having between 36 and 80 inch arc length and operating at power levels up to four-hundred watts per inch (400 W/in). UV lamps 522 generate tremendous heat so the lamps may be contained in an air or water cooled module. Behind the lamp, often a reflector or optical mirror is positioned that provides additional infrared (IR) filtering. Although UV lamps 522 are rated at power levels of up to four-hundred watts per inch (400 W/in) and more, normally UV higher rated lamps produce relatively higher rates of UV energy. The cure rate for one four-hundred watts per inch (400 W/in) lamp is more than double that of two two-hundred watts per inch (200 W/in) lamps because the four-hundred watts per inch (400 W/in) lamp has a higher UV output efficiency. Therefore, normally the highest wattage rated lamp for the application is used rather than multiple lower rated lamps. A UV output efficiency of between over fifty percent (50%) is usually necessary for economical operation. Practically speaking, most commercial mercury UV lamps rated above two-hundred watts per inch (200 W/in) operate at efficiencies in excess of sixty percent (60%). In accordance with an exemplary curing section, UV lamps 522 are comprised of one each twenty-four to forty-eight inch (24 in-48 in) arc length (lamp size is usually determined by the equipment manufacturer and based on width of the laminated substrate intended to be cured with the apparatus). In further accordance with the exemplary curing section, each lamp is rated between two-hundred and three hundred watts per inch (200-300 W/in) with a UV output efficiency of between sixty and seventy percent (60% and 70%). An exemplary UV lamp, as well as lamp module, is available from UVEXS Incorporated, 1260 Birchwood Drive, Sunnyvale, Calif. 94089-2205. Although FIG. 5A depicts two UV lamps 522, many commercial curing operations use only a single UV lamp, however the inclusion of a second lamp allows for faster conveyor speeds during a production run.

While traversing curing section 520, sheets 508 remain in the substantially horizontal plane with UV lamps 522 positioned directly above. Curing section 520 is substantially sealed, thereby keeping harmful UV rays inside the structure but detrimentally also building temperatures therefore, it is often necessary to provide an external cooling source for exhausting excess internal heat generated by UV lights 522.

Curing the liquid laminate requires that sheet 508 be exposed to UV lights 522 for a predetermined amount of time that varies with the laminate application. Thicker laminate depths d′ require longer exposure to UV rays and thus, longer curing times but typical curing times for laminate depths of between 0.5 mils.-5.0 mils. (0.0127 mm-0.127 mm) vary proportionally between one-half second and one and one half seconds (0.5 and 1.5 sec.). Often, curing time is measured by the speed of the product that passes a stationary point, i.e. linear feet per minute (ft./min.) but, for the purpose of this disclosure, curing time will be the total exposure time to the energy source. Temperatures resulting from typical curing operation can exceed 200° F. in the laminated sheet (laminate, graphics image and substrate). Therefore, a significant “cool down” period is necessary prior to performing subsequent operations on the laminated sheets.

After exiting curing section 520, sheet 508 is passed to post-curing section 530 for residual curing and cool down. Generally, prior art laminators utilize a conveyor that is identical to pre-curing conveyor 512, FIG. 5A depicts horizontal post-conveyor 532 in accordance with this embodiment. Additionally, however, the prior art teaches another type of conveyor in which sheets 508 are individually held by “wickets.” FIG. 5B depicts a wicket conveyor 536 used for post curing which will be described in greater detail below. The post-curing process is similar in many respects to the pre-curing process in that traversing post-processing section 530 alters the physical properties associated with sheet 508. Post-curing section 530 acts primarily as a cool-down apparatus, allowing time for sheet 508's latent heat to be transferred to the surrounding air and its temperature to cool. Cool-down time is related to the speed at which post-cure conveyor 532 moves sheet 508 and the length of post-cure conveyor 532. Thicker laminate depths d′ increase the overall mass of sheet 508 and require a correspondingly longer period of cool-down time, therefore either the conveyor's speed must be decreased or the floor space footprint of post-cure section 530 must be increased to accommodate a longer track for horizontal post-curing conveyor 532. However, unlike the pre-curing process, the post-curing process can be accelerated, somewhat, by jetting air onto and around sheets 508. The most practical manner for circulating air around the individual sheets is to use an air handler for encapsulating horizontal post-cure conveyor 532. The air handler physically resembles a tunnel and is represented in FIGS. 5A and 5B as cool down cave 534. Cooler air is injected to cool down cave 534 at the distil end of horizontal post-cure conveyor 532 and circulates around the sheets. As the air flows from the distil end to the curing end of horizontal post-cure conveyor 532, the air is gradually warmed by heat given off by the sheets. The warmed air is exhausted at the curing end. Cooling efficiency is thereby increased, allowing for a smaller post-cure conveyor 532 footprint and/or an increase in the conveyor's speed. Regardless, once the post-curing cool down process has been accomplished, sheets 508 are unloaded to delivery conveyor 540 and delivered to, for example, a load leveling pallet where the individual sheets 508 are stacked in anticipation for subsequent processing.

As an alternative to using a horizontal conveyor, post-curing section 530 may instead employ wicket conveyor 536 shown in FIG. 5B. Wicket conveyor 536 holds each of sheets 508 off of the conveyor tracks and skewed to the direction of travel. Sheets 508 are held approximately parallel with one while traversing the straight portions of wicket conveyor 536 and closely spaced along the conveyor. Wicket conveyor 536 forms a continuous loop, having a straight upper track portion, a straight lower track portion and a pair of curved end portions of track that adjoin each end of the straight upper and lower track potions. Wicket conveyor 536 supports a series of wickets 538, each of which captures and conveys sheets 508 from curing section 520. Each wicket 538 is attached to the wicket conveyor track such that the plane of the wicket is oriented at a predetermined angle to the tangent of track at the attachment point and remains at approximately that same angle with respect to the tangent of track at any point around wicket conveyor 536. Generally, wicket 538 moves in a direction that is also tangent to the track at its attachment point therefore, each wicket 538 is maintained at approximately the same predetermined angle to its direction of the travel at any point around wicket conveyor 536. The relative angle is maintained over straight portions of the conveyor track, as well as over curvilinear portions of the conveyor track.

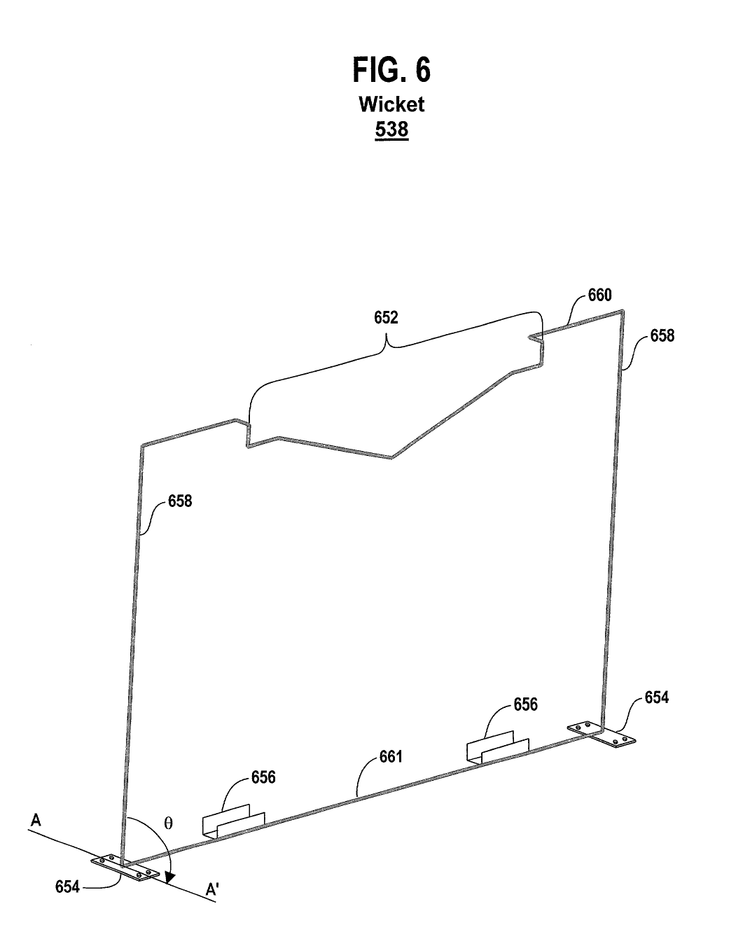

In an effort to better understand the operation of wicket conveyor 536, an individual wicket 538 will be described in conjunction of the operation of post-curing section 530. FIG. 6 is a diagram depicting a typical wicket used for conveying sheets along a wicket conveyor. Wicket 538 holds and controls sheets 508 during transport along wicket conveyor 536. Wicket 538 maintains sheets 508 at a predetermined angle with respect to the direction of travel, such that sheets may be densely spaced along wicket conveyor 536. A typical wicket maybe constructed from any cross-sectional shaped stock (round or tubular stock is depicted) but may instead be fabricated from planar flat stock as a continuous sheet of material (not shown). The composition material of wicket is relatively unimportant but it must be a rigid and durable material, steel for instance. However, in applications where wicket 538 is exposed to UV radiation, as will be discussed with respect to exemplary embodiments of the present invention, the material must also be UV resistant. Wicket 538 serves one primary function, holding a sheet being transported on wicket conveyor 536. The outer dimensions of wicket 538 must accommodate the dimensions of sheet being transported. Generally, perpendicular supports 658 should be larger than one dimension of the sheet while parallel supports 660 and 661 should be shorter than the other dimension of the sheet to be transported by wicket 538. The dimensions of a wicket are somewhat less important when the wicket is constructed from flat stock.

As can be seen in FIG. 5B, sheet 508 is presented to a wicket positioned proximate to curing section 520, that wicket is oriented in a substantially horizontal plane just prior to contacting the sheet. Wicket conveyor 536 continually transports wickets in the direction of the arrows depicted in FIG. 5B. Sheet 508 is picked up by wicket 538 and comes to rest against the forward facing sides of perpendicular supports 658 of that wicket. After that wicket picks up sheet 508, it follows the curve of wicket conveyor 536 in the direction of the arrows toward post-curing section 510. Sheet 508 is reoriented into a near upright or vertical position by wicket 508 as the wicket moves with the curve of the track from the curing end to the upper track portion in post-curing section 510.

During the reorientation, sheet 508 slides downward along the forward facing sides of perpendicular supports 658 until the lower edge of sheet 508 abuts forward catches 656 located on parallel support 661. Forward catches 656 are depicted in FIG. 6 as segments of channel stock, but may be configured differently, for instance as “J” hooks, attached at intervals along parallel support 661. In accordance with other embodiments, forward catches 656 may be eliminated completely in lieu of forming a mirror image of rear catch 652 onto parallel support 661, the function of rear catch 652 will be described below. Sheet 508 then travels through pre-curing section 510. Sheets 508 riding wickets 538 are approximately parallel with one another and closely spaced while on the straight portions of wicket conveyor 536 located at the upper track portions and the lower track portions.

Brackets 654 are used for fastening wicket 538 to the track of wicket conveyor 536. Brackets 654 are rigidly joined to parallel support 661 such that angle θ is formed between respective perpendicular supports 658 and the plane of brackets 654. Angle θ is measured from the rear facing side of wicket 538. Correspondingly, angle θ also represents the angle between the plane of wicket 538 and the direction of travel of wicket conveyor 536. More correctly, angle θ is the orientation of the plane of wicket 538 with respect to the tangent of wicket conveyor 536, depicted in FIG. 6 as line A-A′, at the point where wicket 538 is attached to the track (line A-A′ also represent the direction of travel of wicket conveyor 536 at the attachment point). As wicket 538 is conveyed around the contour of wicket conveyor 536, the magnitude angle θ remains constant even though the plane of wicket 538 is reoriented as the wicket follows the contour of the track. The magnitude of angle θ must be below ninety degrees (90°) in order for sheets 508 to rest against the sides of wickets 538. As will be understood from the description below, the absolute magnitude of angle θ is not critical to every embodiment of the present invention and in accordance with some embodiments, wicket 538 may operate satisfactorily over a wide range of angle θs. However, in accordance with prior art embodiments, the magnitude of angle θ is nominally set at seventy-five degrees (75°) thus, whenever wicket 538 is in pre-curing section 510, the plane of wicket 538 is oriented approximately fifteen degrees (15°) off vertical. In accordance with the prior art, wicket 538 is tilted slightly away from the direction of travel.

After traversing the upper track portion (post-curing section 510), wicket 538 follows the curve of the track downward and around the distil end. At the distil end of wicket conveyor 536, sheet 508 is transferred from one wicket to the next, or preceding wicket (with respect to the direction of travel) on wicket conveyor 536. Sheet 508 first drops from the forward facing side of wicket 538 (the wicket presently holding sheet 508) to the rear facing side of the preceding wicket on wicket conveyor 536. Operationally, first the upper end of sheet 508 drops onto the rear facing sides of perpendicular supports 658 of the preceding wicket. At this point sheet 508 is straddling between a pair of wickets, the wicket that carried the sheet up to this position and the preceding wicket on the conveyor. As the pair of wickets continue around and down the distil end of wicket conveyor 536, the upper end of sheet 508 slides down the rear facing sides of perpendicular supports 658 and falls into rear catch 652 on parallel support 660. The front face of sheet 508 (usually the printed or laminated side) comes completely to rest on the rear facing sides perpendicular supports 658 of the preceding wicket. As the preceding wicket continues around the distil end of the conveyor, sheet 508 remains securely in the grasp of into rear catch 652 and on the rear facing sides of perpendicular supports 658. The preceding wicket and sheet 508 continue around the distil end as the preceding wicket follows the contour of the track to the lower track portion of wicket conveyor 536 and then finally returns to the curing end. At the curing end of wicket conveyor 536, sheet 508 is unloaded to delivery conveyor 540 and then delivered to a load-leveling pallet to await subsequent processing.

A post-curing section that uses wicket conveyor 536 in accordance with the prior art realizes a tremendous reduction in the size of the floor surface footprint necessary for the post-curing section. Exemplary wicket 538 is oriented at approximately seventy-five degrees off tangent (angle θ), as shown in FIG. 6, which permits loading of up to ten sheets on wicket conveyor 536, in the same track space as previously utilized for a typical 24×40 in. sheet.

Additionally, because wickets travel on both upper and lower tracks simultaneously, the footprint is further reduced by nearly half again. The footprint of post-curing section 530 may be further reduced by utilizing cool down cave 534 for accelerating the cool down of sheets 508 as described above with respect to FIG. 5A.

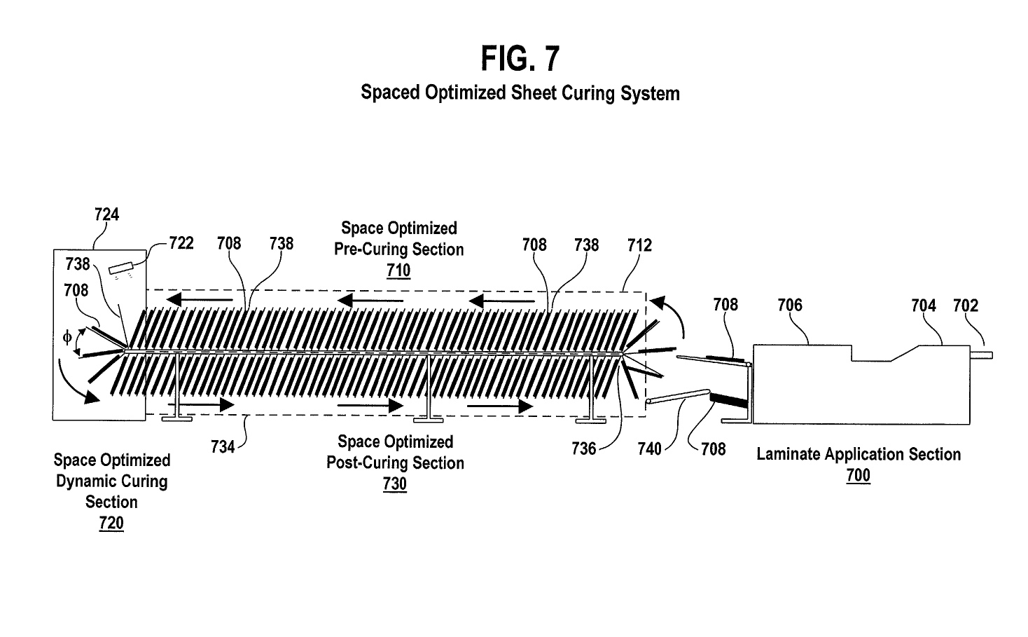

The use of a wicket conveyor in a curing system has resulted in a significant reduction in floor space necessary for post-curing processing however, even greater optimizations of floor space requirements are realized by the present invention. Prior art wicket conveyors have been relegated to post-curing processes largely because printed sheets ride on both the front and rear surfaces in the trip around the wicket conveyor. The wickets would damage any uncured surfaces. In response to the foregoing and in accordance with an exemplary embodiment of the present invention, a system for optimizing floor-space footprint is disclosed that is suitable for more than post-cure processing. FIG. 7 is a diagram of a spaced optimized sheet curing system that utilizes a wicket conveyor for pre-curing operations in accordance with an exemplary embodiment of the present invention. The space optimized sheet curing system depicted in FIG. 7 employs a heretofore unknown method for realizing high quality curing of, for example, liquid laminate in accordance with another exemplary embodiment of the present invention. In accordance with still another exemplary embodiment of the present invention, a system and method for obtaining high quality lamination results for thickly layered laminates using liquid laminate mediums is disclosed. In addition to the system and method described above, the laminated product resulting from the use of liquid laminates in the above mentioned system and method is disclosed which achieves laminate attributes from liquid laminates that were unknown in the prior art. A spaced optimized sheet curing system that utilizes a wicket conveyor for both pre- and post-curing operations is also disclosed in accordance with another embodiment of the present invention. To be used in combination with pre- and/or post-curing operations described above, a novel apparatus and method for curing sheet products is disclosed in accordance with another embodiment of the present invention. These and other embodiments will become apparent with the description the invention depicted in FIGS. 7-10.

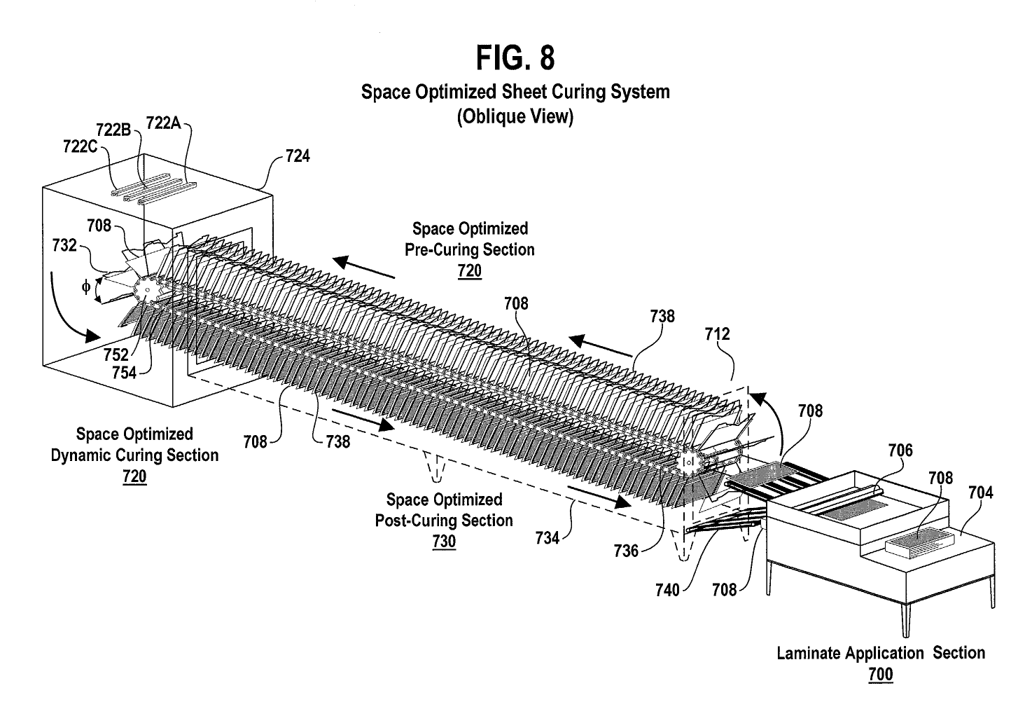

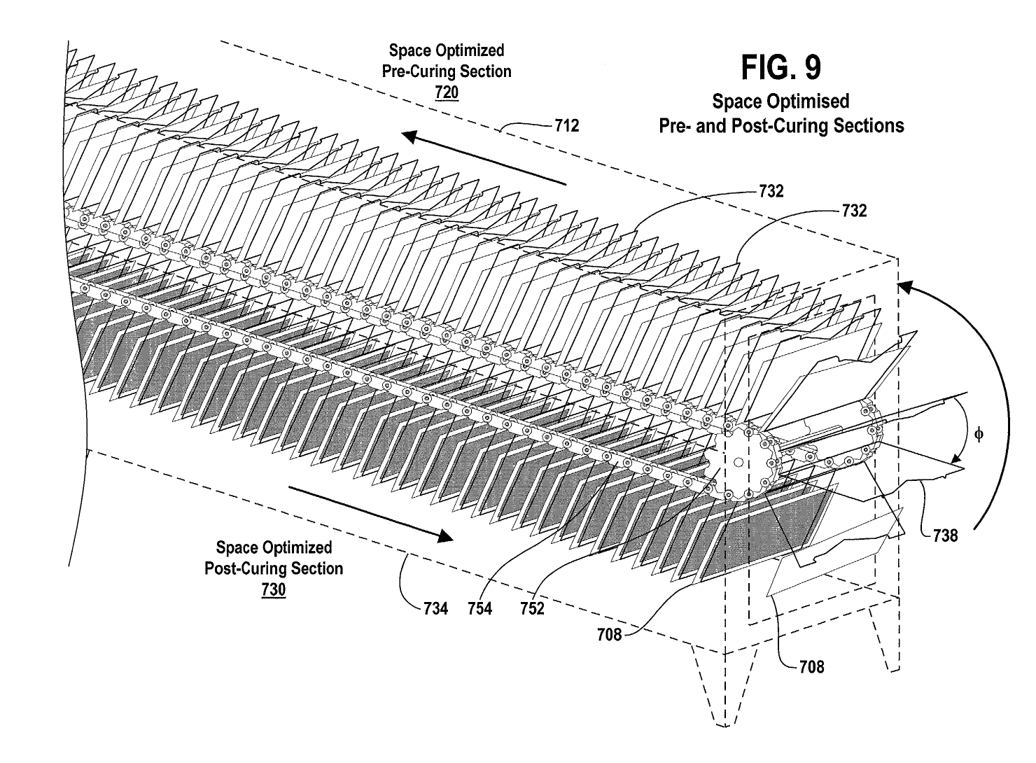

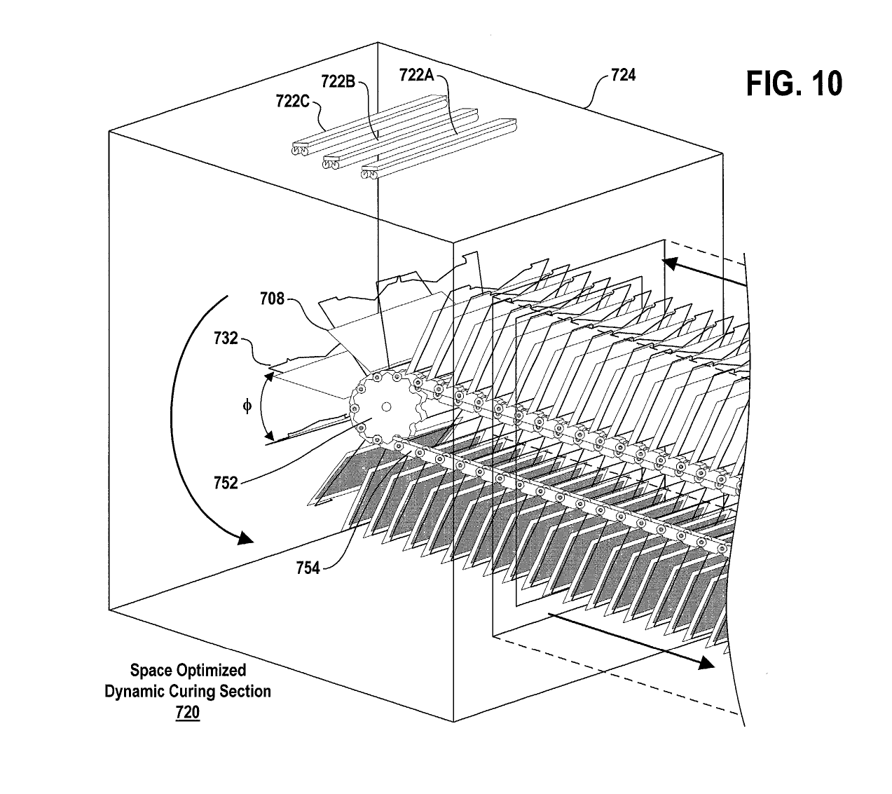

With respect to the figures, FIG. 7 is a diagram of a side view of a space optimized sheet curing system, while FIG. 8 is an illustration showing an oblique view of the space optimized sheet curing system depicted in FIG. 7. FIGS. 9 and 10 are diagrams depicting enlarged oblique views of portions of the space optimized sheet curing system depicted in FIGS. 7 and 8. FIG. 9 shows the pre-and post-curing sections while FIG. 10 shows the curing section of exemplary embodiments of the present invention. For clarity, element numbers used to identify the components of the present invention in the figures will remain constant for an element throughout each of the drawing figures.

Turning now to FIGS. 7 and 8, a space optimized sheet curing system is depicts comprising space optimized pre-curing section 710, space optimized dynamic curing section 720 and space optimized post-curing section 730. FIGS. 9 and 10 depict enlarged views of pre- and post-curing sections 710 and 730, and curing section 720, respectively. With respect to the present pre-curing apparatus, a wicket conveyor is disclosed for holding a plurality sheets during pre-curing operations in accordance with a preferred embodiment of the present invention. The wicket conveyor holds the sheet off of the conveyor tracks and skewed to the direction of travel. The sheets are closely spaced and approximately parallel with one another with on straight portions of wicket conveyor thereby optimizing pre-curing floor space area in accordance with another exemplary embodiment of the present invention. Also, while the sheets are skewed to the direction of travel, the sheets are also oriented approximately vertical which precipitates dynamic sheet flow of uncured coatings across the face of the sheets in accordance with another exemplary embodiment of the present invention. Still further, the present pre-curing apparatus is readily combinable with other devices that are typically used for curing coated substrate sheets and thereby realizes an even greater optimization of floor space in accordance with other embodiments of the present invention.

Also depicted in FIGS. 7 and 8 is laminate application section 700 which may be identical to that of laminate application section 500 described above for liquid laminating operations however, in no way is the scope of the present invention merely limited to laminating operations. With respect to laminating operations however, printed sheet 708 begins in a horizontal orientation in a stack of printed sheets at sheet feeder 702 and is then passed through to screen section 706 where a coat of liquid laminate is applied.

Moreover, a heretofore unrealized liquid laminate product is now possible that imparts to a viewer the visual effect of realizing an underlying graphics image is a glossy, high luster image with a deep, wet appearance and that seemingly enhances contrast and color shades producing deep, vivid color tones. This visualization is possible because the present invention allows thicker applications of liquid laminates onto a graphics images with fewer trapped air bubbles in the liquid laminate and a smoother, less irregular surface than was attainable from prior art methods. FIG. 4 is an illustration that represents cut-away views of a laminated product similar to that depicted in FIG. 3 above, but showing a thicker depth of liquid laminate, with fewer bubbles and a smooth surface texture in accordance with an exemplary embodiment of the present invention. FIG. 4 is a cut-away view representing a laminated product wherein a graphics image is layered onto a substrate, which in turn is overlaid with a liquid laminate in accordance with an exemplary embodiment of the present invention. Graphics image 404 has been applied to substrate 402 and then liquid laminate 408 is applied directly to the surface of graphic image 404 and substrate 402. Liquid laminate 408 possesses certain laminate attributes that give a viewer the sense that the underlying graphics image as a glossy, high luster image with a deep, wet appearance that seemingly enhances contrast and color shades producing deep, vivid color tones. These attributes include a smooth surface textured laminate having a depth of twelve (12.0) mils. or greater and further having a gloss level of 97.0 gloss units or greater measured with a gloss meter configured with a sixty degree (60°) reference angle. Notice also that although depth d′ is greater than depth d depicted in FIG. 2, the resulting increase in depth does not result in a corresponding increase in the quantity of air bubbles 410 trapped in the liquid laminate layer. Most trapped air has flowed out of liquid laminate 408, even though the depth d′ is greater than that realized by liquid laminates of corresponding thickness in the prior art and the surface is smooth, further resulting in an overall degree of a gloss level of 97.0 gloss units at 60°.

An exemplary liquid laminate product is a UV screen coating available from Sun Chemical Corporation, 1505 109^{th} Street, Grand Prairie, Tex. 75050 and is listed as product number “RCKKV0481748.” RCKKV0481748 is clear, UV curable and applied using a screen process. Although drying agents are unnecessary, liquid silicon, also available from Sun Chemical Corporation, is sometimes added to “create flow” for the screen application process. In order to achieve the desired visual effect, that of a glossy, high luster image with a deep, wet appearance, the liquid laminate is applied on a substrate, usually a coated substrate and/or graphics image at a depth of twelve (12.0) mils. (0.305 mm) or greater in accordance with an exemplary embodiment of the present invention. The upper limit of the laminate thickness is not bound by degradation of the visual effect but instead, is limited by the proclivity of thicker laminate layers to chip. Therefore, in practice, laminate depths are limited to approximately forty (40.0) mils. (1.016 mm) due to tendency of the cured laminae to chip during cutting and shearing operations. However, in certain lamination applications where a lower laminate hardness value is acceptable, chipping may be reduced by softening the laminate layer thereby allowing for even thicker laminate depths at forty (40.0) mils. (1.016 mm). In accordance with an exemplary embodiment of the prior invention, RCKKV0481748 is applied to a substrate at a rate between twelve pounds per hundred sheets and forty pounds per hundred sheets (12.0 lbs./100-40.0 lbs./100) of a typical 24×40 in. sheet stock in order to achieve laminate depths between twelve (12.0) mils. and forty (40.0) mils. (0.305 mm and 1.016 mm) on the substrate.

Surface particular matter is kept at or below a nominal level, less than two observable surface imperfections per five square inches (5.0 in²), where an observable surface imperfection is a surface deformation greater than one-half millimeter (0.5 mm), although this requirement is somewhat subjective and may be changeable to suit the particular laminate application. After curing, the exemplary laminate layer is extremely smooth and has an observable gloss level of 97.0 gloss units or greater at sixty degrees (60°). In accordance an exemplary embodiment of the present invention the minimum gloss level of the lamination process is 97.0 gloss units at sixty degree (60°) but in practice the actual gloss level may be much higher. A nominal range for gloss using the present invention is between one-hundred and five gloss units and one-hundred and twenty gloss units (105.0-120.0 gloss units). In any case, an increase of at least five gloss units (5.0) is expected between a laminate application utilizing the present invention and an identical laminate application using prior art lamination techniques. By using the above described laminate layer attributes in conjunction with the present lamination process, a superior quality laminated product may be achieved using thickly layered liquid laminates that were not possible using prior art methods and system.

It should be understood that a significant vacuum forms between the extraordinarily smooth laminated surfaces of two adjacent substrate sheets laminated in accordance with an exemplary embodiment of the present invention. The magnitude of the vacuum is sufficient to disrupt the normal operation of typical sheet processing equipment associated with, for instance, a typical printing facility. Therefore, steps must be taken to ensure that two smooth, high gloss surfaces are not stacked in a face-to-face arrangement. Normally, this problem can be avoided by thickly laminating only one side of a sheet substrate. For example, applying liquid laminate to one side at a rate sufficient to achieve a nominal gloss range of between one-hundred and five gloss units and one-hundred and twenty gloss units (105.0-120.0 gloss units), approximately twenty (20.0) mils. to forty (40.0) mils. (0.508 mm-1.016 mm) in depth, while on the second side of the sheet, reducing the rate of laminate application to less than twelve (12.0) mils. (0.305 mm) in depth. Even using the exemplary lamination process described herein, the second side will not achieve the prerequisite smoothness to form a vacuum with another sheet. If, however, a demand is realized for two-sided thickly laminated sheets of substrate processed in accordance with the present invention, steps must be taken to ensure that the sheet surfaces are not in contact with one another. Providing a non-laminated sheet material interposed between laminated sheets is one possibility, but a costly solution.

Prior art attempts to achieve high quality thickly laminated products resulted in new difficulties unresolved by experience with thinly laminated surfaces. Thick laminate depths, d′, produced laminate surface irregularities from the application of liquid laminate to the substrate itself (orange peel) and/or from air bubbles trapped near the surface that were not able to be purged from the laminate layer prior to curing the laminate. While in many cases the occurrence of larger air could be diminished somewhat, attaining smooth surface textures remained beyond the reach of the prior art because the extraordinarily long flow-out time necessary for smoothing surfaces where the height disparity between adjacent high and low areas is relatively low, such as for orange peel and small bubbles trapped near the surface. In practice, while gravitational and surface tension forces might be sufficient to overcome the internal forces of thicker laminates, the time necessary to accomplish necessary surface smoothing to achieve the desired visual effect remained beyond that available for a commercial product. The liquid laminate simply does not flow out adequately to achieve the desired visual effect in accordance with the prior art pre-curing operations.

Returning to FIG. 7, once liquid laminate has been applied, sheet 708 exits laminate application section 700 and is fed onto wicket conveyor 736. Wicket conveyor 736 is an exemplary conveying means comprised of a pair of sprockets 752 for supplying rotational power to conveyor track or chain 754. It should be understood that the particular type of conveyance system is not limited by the present invention. While a chain and sprocket type of conveyor is depicted, belt and roller conveyor types can be adapted to the present invention equally well. Moreover, the ordinary artisan will realize that many of the benefits associated with various embodiments of the present post-curing apparatus may be realized using other still conveyance systems such as pallet and roller type of conveyor. In that system pallets that ride along rollers are fixed with wickets in the manner describes herein, for hold the individual substrate sheets. Returning to the exemplary conveyance system, the direction of chain 754 is shown as by arrows adjacent to wicket conveyor 736. Attached to individual links of chain 754, at predetermined intervals, are wickets 738. One of ordinary skill in the art will readily realize that the configuration of wicket 738 depicted in the figures is merely exemplary and, as discussed above with respect to FIG. 6, and rigid or semi-rigid substrate holding member may suffice for a particular application. In accordance with particular embodiments of the present invention, the construction and use of wicket conveyor 736 is similar to that of prior art wicket conveyor 536 described above, therefore only the distinctions between wicket conveyor 736 and prior art wicket conveyor 536 will be described in depth.

Readily apparent from the illustration of the figures is that sheet 708 is transferred through each of the pre-curing, curing and post-curing sections while loaded on wicket conveyor 736. With respect to laminating printed sheets with a liquid laminate, utilizing wicket conveyor 736 for pre-curing operations ensures higher quality laminated products especially using thicker liquid laminate depths d′. Recall that prior art laminating operations using liquid laminates are plagued with shortcomings that result in poorly processed laminates, represented in FIG. 3, resulting in a high concentration of bubbles 310 and a generally rough surface texture of liquid laminate 308.

By contrast, and as depicted in FIGS. 7-10, space optimized pre-curing section 710 brings about dynamic liquid laminate flow out that was unattainable in the prior art and high quality laminated products are achieved using liquid laminates via the present invention. Dynamic flow out, or laminate “sheet flow”, takes place because sheets 708 are oriented in a near vertical orientation on wicket conveyor 736, in accordance with a preferred embodiment of the present invention rather than in a horizontal orientation as in the prior art pre-curing operations. As wicket 738 and corresponding sheet 708 enter space optimized pre-curing section 710, wicket conveyor 736 is on the upper track portion of the conveyor which is substantially horizontal. Sheet 708, resting against the forward side of wicket 738, is at an angle θ, of approximately seventy-five degrees (75°) from horizontal, but the absolute magnitude of angle θ is not crucial to the invention, instead what is required is that dynamic flow-out be achieved by reorienting sheet 708 off horizontal. Then, rather than laminate flow-out being limited to gravity forcing liquid laminate to flow from higher peaks into lower valleys on the surface, the entire sheet of liquid laminate tends to flow down sheet 708, in dynamic sheet flow. Thus, gravitational forces are amplified as liquid laminate sheet flows down sheet 708, smoothing the disparities between the peaks and valleys of an irregular surface in accordance with an exemplary embodiment of the present invention.

Notice also that by reorienting sheets 708 away from horizontal, in contrast to that taught in the horizontal conveyor pre-curing operations of the prior art, to a near vertical orientation using space optimized pre-curing section 710, many more sheets can be simultaneously pre-cured in the same amount of floor space. Individual sheets are aligned in a substantially parallel planar orientation, relative to one another, spaced proportionally to a corresponding wicket's positions on wicket conveyor 736. Thus, the prerequisite floor space footprint may be reduced and/or higher conveyor speeds may be attained for efficiently producing more laminated sheet product in accordance with an exemplary embodiment of the present invention. The factory floor space footprint is further optimized by situating pre-curing section 710 directly over post-curing section 730, thereby reducing the floor space footprint requirement by establishing a coexisting footprint for both operations. Product wastage is reduced by interposing a drip pan (not shown) between the upper track portion (pre-curing section 710) of wicket conveyor 736 and the lower track portion (post-curing section 730). The drip pan may be incorporated in pre-curing cave or tunnel 712, which protects sheets 708 from airborne contaminates and ambient UV rays.

Once sheet 708 has traversed space optimized pre-curing section 710, the sheet enters space optimized dynamic curing section 720 located at the distil end of wicket conveyor 736 as shown in FIGS. 7 and 8 and which is more particularly represented in FIG. 10. In accordance with an exemplary embodiment of the present invention, space optimized dynamic curing apparatus is disclosed which dynamically cures coatings on either side of a substrate sheet. The dynamic curing apparatus comprises a wicket conveyor for transporting substrate sheets with a plurality of sheet holding mechanisms for holding individual sheets off of the conveyor tracks and skewed to the direction of travel, thereby allowing more complete penetration of curing rays in accordance with another exemplary embodiment of the present invention. During curing, sheets are passed from one sheet holding mechanism to another, thereby assuring that the curing rays are not obstructed by either of the sheet holding mechanisms. Still further, the present invention allows for the complete curing of residual coatings on backside surfaces of substrate sheets and superfluous coatings on the conveyor and sheet holding mechanisms. In accordance with other exemplary embodiments of the present invention, a curing carousel is disclosed with a plurality of sheet holding mechanisms for picking up uncured sheets, revolving them into curing rays and then unloading the cured sheets, wherein the sheet holding mechanisms hold individual sheets off of the conveyor tracks and skewed to the direction of travel, thereby allowing for complete penetration of curing rays and dynamic sheet curing. In accordance with still other exemplary embodiments of the present invention, a dynamic curing apparatus is disclosed with fully configurable curing sources for aligning curing rays. In accordance with still other exemplary embodiments of the present invention, a novel use of a wicket conveyor is disclosed which allows for sheets to be closely spaced along straight portions of the conveyor and still fully curing coatings on either side of the sheets as the sheets traverse a curve in the conveyor.

Returning to FIGS. 7 and 8, sheets travel, and are transferred between wickets, on wicket conveyor 736 in the identical manner as described with respect to the distil end of wicket conveyor 536 with reference to FIG. 5. However, rather than merely rounding the distil end of wicker conveyor 736 in route to the lower track portion as taught in the prior art, sheet 708 is dynamically cured while at the distil end. Notice that space optimized dynamic curing section 720 utilizes only slightly more floor space than is necessary for the wicket conveyor itself thus, floor space is further optimized in accordance with a preferred embodiment of the present invention. In addition to providing additional space optimization over the prior art, curing section 720 dynamically cures any liquid laminate proximate to sheet 708, whether the laminate is present on the front, rear or sides of sheet 708 or even on wicket 738 or links on chain 754.

Operationally, curing occurs simultaneously with sheet 708 being transferred from the forward facing side of one wicket to the rear facing side of the preceding wicket. Curing (here again, an exemplary curing process is described involving UV radiating a UV curable liquid laminate) is initiated at the approximate position on wicket conveyor 736 where the wickets follow the contour of the upper track portion around the distil end. One end of each of wickets 738 is physically attached to wicket conveyer 736, while the wicket's opposite end is free to move with respect to adjacent wickets on wicker conveyor 736. As wicket 738, and corresponding sheet 708, approach the distil end of wicket conveyor 736, sheet 708 and the preceding sheet are substantially parallel to one another. When viewed from above, a good deal of the upper surface of sheet 708 is obscured by the preceding sheet that is riding on the preceding adjacent wicket. However, as the preceding wicket reaches the distil end, it follows the contour of the track and sprocket 752, and the outer edge of the preceding sheet falls away, thereby exposing sheet 708 from above. Typically, curing takes between thee to seven seconds (3.0 to 7.0 secs.) in accordance with an exemplary embodiment of the present invention for laminate depths of between twelve (12.0) mils. and forty (40.0) mils. using the three lamp configuration shown in FIG. 10. It is precisely this point along wicket conveyor 736 that direct radiation curing is most effective. As the parallel alignment of the two sheets is disrupted, a gap opens between the upper edges of the sheets. UV lamp 722 is positioned proximate to the distil end of wicket conveyor 736 and oriented such that UV rays are aimed into the gap formed between adjacent sheets. UV radiation from UV lamp 722 permeates the void between the sheets and is absorbed by all unobstructed surfaces. The forward facing surface of both sheets, and well as unobstructed portions chain 754 and the wicket, including the front catches that hold the sheets, absorb UV radiation. As the sheets continue along the distil end of wicket conveyor 736, the preceding sheet falls forward onto the rear side of its preceding adjacent wicket. The back side (unlamented side) of the preceding sheet is then exposed to the radiation form UV lamps 722, as well as opening the gap wider and further exposing the forward face sheet 708 to the UV rays. Additionally, once a sheet is transferred between wickets, the forward facing side of the empty wicket, as well as the remainder of the forward catches, are also bathed in UV radiation. Any residual liquid laminate on any of these surfaces is rapidly cured and therefore is no longer capable of causing wasted product through contamination. Because space optimized dynamic curing section 720 dynamically cures all surfaces of sheet 708, as well as wicket conveyor 738, product waste is greatly reduced. Furthermore, curing section 720 is extremely adaptable for new and unusual applications because the curing section effectively cleans up UV curable residue thus, operators may use UV curable laminates and the like, for heretofore unknown applications. Specifically, attaining visual effects and products from low viscosity UV curable liquids may be accomplished without any substantial product waste because curing section 720 automatically cures all residue laminate on any surface, whether the front or rear surface and whether the surface is on the substrate sheet or the conveyor.

Space optimized dynamic curing section 720 is also extremely adaptable and configurable being uniquely suited for accommodating a wide variety of UV curing applications. Curing time for a particular application may be adjusted by several procedures in accordance with an exemplary embodiment of the present invention. Conveyor speed maybe adjusted to lengthen or shorten the exposure time for sheet 708 and/or the spacing between adjacent wickets spacing on wicket conveyor 736 may be modified to allow for a larger or smaller gap between adjacent wickets, again increasing or decreasing a sheet's exposure to direct UV radiation. Additionally, rotational spacing between wickets may be modified thereby changing the gap between adjacent wickets at the distil end of wicket conveyor 736. The rotation spacing is related to two factors—the spacing between adjacent wickets and the magnitude of wicket angle φ. Spacing between adjacent wickets is briefly discussed directly above, but the gap between adjacent wickets may depend on a number of variables including: obtaining a specific pre-curing time; conveyance speed; substrate's thickness, especially with respect to the preset orientation of the wicket, angle θ and the preset orientation of the wicket, angle θ. The wicket angle φ, conversely, is inversely proportional to the diameter of sprocket 752; smaller sprocket diameters produce larger magnitudes of wicket angles φ and thus greater rotation spacing between adjacent sets of wickets for the UV rays to penetrate.

Unlike prior art curing sections and in accordance with another exemplary embodiment of the present invention, the pattern of UV irradiation using lamp 722 is highly configurable. In accordance with an exemplary embodiment of the present invention, curing section 720 is a three-dimensional structure that facilitates lamp 722 being positioned and orienting in three20 space. Prior art curing sections limited lamp configurations to planar two-space positions and orientations because the structures themselves were essentially two-space planar structures as depicted by curing section 520 in FIGS. 5A and 5B. The highly configurable UV lamp orientations of the present invention supports the production of high quality laminated products that were unattainable with prior curing sections. For example, superior laminated products having stunning visual effects are possible using thickly layered liquid laminates by utilizing three UV lamp banks, 722A-722C as shown in FIG. 10. Three UV lamp banks dynamically immerse the UV curable liquid laminate on the front side of a sheet with high levels of UV radiation, while limited exposure of the sheet backside to lower levels, i.e. high enough to cure residue laminate without overheating the sheet. Although not specifically shown in the figures, the distance between particular UV lamps 722 and sheet 708 is also configurable for limiting the dispersion of UV rays. In accordance with an exemplary embodiment of present curing section 720, UV lamps 722 are comprised of three separate twenty-four to forty-eight inch (24 in-48 in) arc length lamps wherein the actual arc length may depend on the lamination needs of the facility. In further accordance with the exemplary embodiment of curing section 720 of the present invention, each lamp is rated between two-hundred and three hundred watts per inch (200-300 W/in) with a UV output efficiency of between sixty and seventy percent (60% and 70%), but efficiencies may go higher, up to the theoretical limit of one-hundred percent (100%).

Space optimized dynamic curing section 720 is confined in UV barrier 724 which protect operators and onlookers from the harmful effects of the intense UV radiation generated by UV lamp 722. Additionally, the inner surface of UV barrier 724 may be lined with a reflective surface, thereby more evenly distributing both indirect UV radiation and also the heat generated from the curing process. Since curing section 720 is substantially sealed by UV barrier 724, thereby keeping harmful UV rays inside the structure, temperatures from the curing process increase rapidly. Therefore it is necessary to provide an external cooling source (not shown) for exhausting excess internal heat generated by UV lamps 722.

Once curing is completed, sheet 708 enters space optimized post-curing section 730 from curing section 720 without being transferred to another conveying system as is the practice in prior art post-curing sections. With respect to the present post-curing apparatus, a wicket conveyor is disclosed for holding a plurality of sheets during post-curing cool down operations in accordance with a preferred embodiment of the present invention. The wicket conveyor holds the sheet off of the conveyor tracks and skewed to the direction of travel and the sheets are closely spaced to one another along the conveyor thereby optimizing floor space area for the post-curing apparatus in accordance with another exemplary embodiment of the present invention. Still further, the present post-curing apparatus is readily combinable with other devices typically used for curing coated substrate sheets and thereby realizes an even greater optimization of floor space in accordance with still another embodiment of the present invention.

Notice from FIGS. 7-10 that space optimized post-curing section 730 is substantially parallel to space optimized pre-curing section 710 and that space optimized post-curing section 730 utilized the lower track portion of wicket conveyor 736. Thus, the inclusion of post curing section 730 to the space optimized curing system of the present invention does not increase the overall floor space footprint of the curing system.

As sheet 708 continues around the distil end of wicket conveyor 736, it follows the contour of the track to the lower track portion and into space optimized post-curing section 730. The operation of post-curing section 730 is identical to that described above with respect to that of prior art post-curing section 530 depicted in FIG. 5B. As a sheet traverses space optimized post-curing section 730, the excess curing heat of sheet 708 gradually warms the surrounding air whilst reducing the latent heat in sheet 708. Encapsulating space optimized post-curing section 730 in an air handler may further reduce cool down times. The air handler, described above with respect to FIGS. 5A and 5B, physically resembles a tunnel and is depicted in FIGS. 7-10 as cool down cave 734. Cooler air is injected to cool down cave 734 at the distil end of post-curing section 730 and a fan circulates the air around the cured sheets, i.e. a convection cooling operation. As the air flows from the distil end, the circulated air is gradually warmed by heat given off by the sheets and is finally exhausted at the curing end of the space optimized post-curing section 730. Cooling efficiency is thereby increased, reducing cooling time and allowing for smaller floor space footprints for space optimized post-cure section 730 and/or increasing the conveyor's speed. Once sufficiently cooled, sheet 708 is unloaded to delivery conveyor 740 and then delivered to a load-leveling pallet to await subsequent processing.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention and the practical application and to enable others of ordinary skill in the art to understand the invention for various embodiments with various modifications as are suited to the particular use contemplated.

The present invention has been primarily described with respect to a UV curable liquid lamination process, but the present invention is equally adaptable to other processes without departing from the intended scope of the present invention. The present invention is well suited for other curing processes for example, infrared (IR), radiant heat or even laser cured products, may by cured efficiently using the present invention. Similarly, although the present invention has been described primarily as a sheet lamination process, the present invention is well suited for processing sheet coatings and other UV curable liquid laminates for example, curable inks and colored or tinted coating, as well as certain film and/or other laminating materials. The present invention cures most resin products exceptionally well and efficiently processes various substrate shapes even those not being configured as a planar sheet. Thus, the present invention is particularly well suited for many laminate applications heretofore excluded from prior art curing processes such as coating printed circuits and circuit boards, manufacturing components needing specialized coatings such as automobile and appliance parts as well as furnishings, energy efficient window panes and home products and even defense applications such as specialized camouflage and radar absorbing coatings. Still further, while the present invention has been described as essentially utilizing wickets for holding and controlling the orientation of sheets, other structures would be apparent to the ordinary artisan without departing from the intended scope of the present invention. Additionally, the wickets have been described in some embodiments as being oriented substantially perpendicular from the tangent of the attachment point on the conveyor track. While this orientation should be maintained for some embodiments, overall floor space optimizations may be achieved over prior art conveyors through a wide range of angle θ. The intent is to stack a high density of sheets in the same conveyor space as was used in prior art systems by a single sheet. Therefore, the spacing between attachment points between adjacent wickets on a wicket conveyor is the determining factor and not the absolute magnitude of the wickets, angle θ. Thus, floor space optimizations may be realized over a wide range of angle Os varying from slightly greater than zero degrees (0°) and slightly less than ninety degrees (90°), for horizontally oriented wicket conveyors. Still further, the present invention has been described throughout as having the wicket conveyor oriented substantially horizontal wherein wickets travel in two directions, parallel to the floor plane. However, other floor space layouts are possible. For example, the wicket conveyor may be oriented in a substantially vertical plane and the individual wickets travel in two primary directions, perpendicular to the floor plane. In accordance with this embodiment, the dynamic curing section is positioned above the surface of the floor and may be located on another level or story of the facility. In further accordance with an exemplary embodiment of the present invention, the space optimized sheet curing system may follow a vertical wall. In this configuration, the curing and post curing sections benefit from the natural tendency of warmer air to stratify at higher elevations than cooler air. Of course, the magnitude of the wickets, angle θ must be adjusted to accommodate the planar orientation of the wicket conveyor. Reorienting the exemplary horizontally wicket conveyor into a vertical orientation must be reflected by a corresponding increase of ninety degrees (90°) in angle θ for achieving similar laminate curing results. Vertical lay out configurations of the wicket conveyor realize extremely small floor space footprints. Similarly, the plane of the wicket conveyor may be tilted at an inclination that is less than vertical. For instance, having the laminating application section on a lower floor and the curing section on a higher floor. In order to achieve similar lamination results in such planar orientations, the magnitude of angle θ must be increased by the magnitude of the incline of the wicket conveyor. Also, while the present invention has been described as having the pre-curing section on the upper track portion of the wicket conveyor and the post-curing section on the lower track portion of the conveyor, other embodiments of the present invention involve swapping the positions of each. There, the magnitude angle θ associated with the individual wickets may be adjusted and the UV curing lamps should be reconfigured in order to accommodate sheet travel from lower to upper portions of track. With respect to such a configuration, individual sheets would probably straddle the space between two wickets in the post-curing section rather than being completely transferred to the adjacent preceding wicket as described above.

What is claimed is:

A1. A pre-curing apparatus for pre-curing a curable liquid applied to a surface of a substrate comprising:
a conveyance system; and
a plurality of substrate holding members, each of said plurality of substrate holding members being adjoined to the conveyance system and conveyed in a predetermined direction, wherein each of said plurality of substrate holding members being configured for holding the surface of the substrate in a preset orientation, the preset orientation askew to the predetermined direction.

A2. The pre-curing apparatus recited in claim Al, wherein the preset orientation is between ninety-one degrees (91°) and one-hundred seventy-nine degrees (179°) to the predetermined direction.

A3. The pre-curing apparatus recited in claim A1, wherein the preset orientation is between ninety-one degrees (91°) and one-hundred thirty degrees (130°) to the predetermined direction.

A4. The pre-curing apparatus recited in claim A1, wherein the preset orientation is between one-hundred thirty degrees (130°) and one-hundred seventy-nine degrees (179°) to the predetermined direction.

A5. The pre-curing apparatus recited in claim A1, wherein a first substrate holding member is adjoined to the conveyance system at a predetermined distance from a second substrate holding member, the predetermined distance being based on one of pre-curing time, conveyance speed, substrate thickness and the preset orientation.

A6. The pre-curing apparatus recited in claim A1, wherein a magnitude of the preset orientation is based on flowing the curable liquid across the surface of the substrate.

A7. The pre-curing apparatus recited in claim A1, wherein a magnitude of the preset orientation is based on one of increasing substrate throughput, decreasing conveyance system size and decreasing conveyance speed.

A8. The pre-curing apparatus recited in claim A1, wherein a magnitude of the preset orientation is based on one of increasing substrate throughput, decreasing conveyance system size and decreasing conveyance speed.

A9. The pre-curing apparatus recited in claim A1 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

A10. The pre-curing apparatus recited in claim A1 above, wherein the substrate is a graphic media including at least one graphics image.

A11. The pre-curing apparatus recited in claim A10 above, wherein the substrate is a graphic media is a printable media and the laminate layer is applied to one of the printable media, graphics image, and printable media and graphics image.

A12. The pre-curing apparatus recited in claim Al above, further comprises:
an enclosure cave, wherein the enclosure cave at least partially encloses a substrate holding member being conveyed in the predetermined direction.

A13. The pre-curing apparatus recited in claim A1 above, wherein the substrate is preprocessed with an ink-receptive coating.

A14. The pre-curing apparatus recited in claim A13 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

A15. The pre-curing apparatus recited in claim A1 above, wherein the plurality of substrate holding members are configured in a preset orientation, the preset orientation askew to the predetermined direction.

A16. The pre-curing apparatus recited in claim A1 above, wherein the substrate holding members being conveyed in the predetermined direction for a predetermined distance.

A17. The pre-curing apparatus recited in claim A16 above, wherein the predetermined distance is based on an amount of time for the curable liquid to pre-cure on the surface of the substrate.

A18. The pre-curing apparatus recited in claim A17 above, wherein the amount of time is based on one of thickness of the curable liquid and the preset orientation of the surface of the substrate.

A19. The pre-curing apparatus recited in claim Al further comprises:
a drip pan for containing residual curable liquid from the surface of the substrate.

A20. The pre-curing apparatus recited in claim A1, wherein the conveyance system is configured with a conveyance portion for conveying a substrate holding members in the predetermined direction.

A21. The pre-curing apparatus recited in claim A20, wherein the predetermined direction is substantially linear.

A22. The pre-curing apparatus recited in claim A20, wherein the conveyance portion is substantially linear.

A23. The pre-curing apparatus recited in claim A20, wherein the conveyance system is substantially horizontal and the conveyance portion is substantially linear.

A24. The pre-curing apparatus recited in claim A20, wherein the predetermined orientation is near vertical.

A25. The pre-curing apparatus recited in claim A20, wherein the conveyance system is substantially vertical and the conveyance portion is substantially linear.

A26. The pre-curing apparatus recited in claim A20, wherein the predetermined orientation is perpendicular to near vertical.

A27. The pre-curing apparatus recited in claim A1, wherein the substrate is positioned on the forward facing side of the a substrate holding member.

A28. The pre-curing apparatus recited in claim A20, wherein the conveyance system is substantially horizontal and the conveyance portion is substantially horizontal.

A29. The pre-curing apparatus recited in claim A20, wherein the conveyance system is substantially vertical and the conveyance portion is substantially vertical.

A30. The pre-curing apparatus recited in claim A28, wherein the substrate is loaded onto a substrate holding member while the substrate is in a substantially horizontal orientation prior to the substrate holding member being conveyed to the substantially horizontal conveyance portion.

B1. An apparatus for pre-curing and post-curing a curable liquid applied to a surface of a substrate comprising:
a conveyance system configured with a first conveyance portion for conveying in a first predetermined direction and further configured with a second conveyance portion for simultaneously conveying in a second predetermined direction; and
a plurality of substrate holding members, each of said substrate holding members being configured for holding a substrate in a preset orientation, the preset orientation askew to one of the first and second predetermined directions, wherein one of the plurality substrate holding members holds a first substrate being conveyed on the first conveyance portion in the first direction during which the curable liquid applied to the surface of the first substrate is pre-cured and further wherein another of the plurality substrate holding members holds a second substrate being conveyed on the second conveyance portion in the second direction during which the curable liquid applied to the surface of the second substrate is post-cured.

B2. The apparatus recited in claim B1, wherein the preset orientation is between ninety-one degrees (91°) and one-hundred seventy-nine degrees (179°) to the first predetermined direction.

B3. The apparatus recited in claim B1, wherein the preset orientation is between ninety-one degrees (91°) and one-hundred thirty degrees (130°) to the first predetermined direction.

B4. The apparatus recited in claim B1, wherein the preset orientation is between one-hundred thirty degrees (130°) and one-hundred seventy-nine degrees (179°) to the first predetermined direction.

B5. The apparatus recited in claim B1, wherein the first substrate holding member is adjoined to the conveyance system at a predetermined interval from a third substrate holding member, the predetermined interval being based on one of pre-curing time, conveyance speed, substrate thickness and the preset orientation.

B6. The apparatus recited in claim B1, wherein a magnitude of the first preset orientation is based on flowing the curable liquid across the surface of the first substrate.

B7. The apparatus recited in claim B1, wherein a magnitude of the first preset orientation is based on one of substrate throughput, conveyance system length and conveyance speed.

B8. The apparatus recited in claim B1 further comprises:
a downloader for downloading a substrate with a post-cured liquid applied to the surface of the substrate is post-cured.

B9. The apparatus recited in claim B1 above, wherein the first substrate is one of cellulose-based pulp paper, cotton-based pulp paper, cardboard, matte, polyethylene (Polythene), cast polypropylene, oriented polypropylene, cellophane, co-extrusions polyvinylchlorid, laminated substrates, metallised film and polyester.

B10. The apparatus recited in claim B1 above, wherein the first substrate is a graphic media including at least one graphics image.

B11. The apparatus recited in claim B10 above, wherein the first substrate is a graphic media is a printable media and the laminate layer is applied to one of the printable media, graphics image, and printable media and graphics image.

B12. The apparatus recited in claim B1 above further comprises:
an enclosure cave, wherein the enclosure cave at least partially encloses the first substrate holding member being conveyed in the first predetermined direction.

B13. The apparatus recited in claim B1 above, wherein the first substrate is preprocessed with an ink-receptive coating.

B14. The apparatus recited in claim B13 above, wherein the first substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B15. The apparatus recited in claim B1 above, wherein a third substrate holding member is configured in a third preset orientation, the third preset orientation askew to the first predetermined direction.

B16. The apparatus recited in claim B1 above, wherein the first conveyance portion continues in the first predetermined direction for a first predetermined distance.

B17. The apparatus recited in claim B16 above, wherein the first predetermined distance is based on an amount of time for the curable liquid to pre-cure.

B18. The apparatus recited in claim B17 above, wherein the amount of time is based on one of thickness of the curable liquid and the preset orientation of the surface of the first substrate.

B19. The apparatus recited in claim B1 further comprises:
a drip pan for containing residual curable liquid from the surface of the first substrate.

B20. The apparatus recited in claim B1, wherein the conveyance system is configured with a first conveyance portion for conveying a plurality of substrate holding members in the first predetermined direction.

B21. The apparatus recited in claim B20, wherein the first predetermined direction is substantially linear.

B22. The apparatus recited in claim B20, wherein the first conveyance portion is substantially linear.

B23. The apparatus recited in claim B20, wherein the conveyance system is substantially horizontal and the first conveyance portion is substantially linear.

B24. The apparatus recited in claim B20, wherein the predetermined orientation is near vertical.

B25. The apparatus recited in claim B20, wherein the conveyance system is substantially vertical and the first conveyance portion is substantially linear.

B26. The apparatus recited in claim B20, wherein the predetermined orientation is perpendicular to near vertical.

B27. The apparatus recited in claim B1, wherein the first substrate is positioned on the forward facing side of the first substrate holding member.

B28. The apparatus recited in claim B20, wherein the conveyance system is substantially horizontal and the first conveyance portion is substantially horizontal.

B29. The apparatus recited in claim B20, wherein the conveyance system is substantially vertical and the first conveyance portion is substantially vertical.

B30. The apparatus recited in claim B28, wherein the substrate is loaded onto a substrate holding member while the substrate is in a substantially horizontal orientation prior to the substrate holding member being conveyed to the substantially horizontal first conveyance portion.

B31. The apparatus recited in claim B1, wherein the preset orientation is between ninety-one degrees (91°) and one-hundred seventy-nine degrees (179°) to the second predetermined direction.

B32. The apparatus recited in claim B1, wherein the preset orientation is between ninety-one degrees (91°) and one-hundred seventy-nine degrees (179°) to the first predetermined direction and to the second predetermined direction.

B33. The apparatus recited in claim B1, wherein the preset orientation is between ninety-one degrees (91°) and one-hundred thirty degrees (130°) to the second predetermined direction.

B34. The apparatus recited in claim B1, wherein the preset orientation is between one-hundred thirty degrees (130°) and one-hundred seventy-nine degrees (179°) to the second predetermined direction.

B35. The apparatus recited in claim B1, wherein the second substrate holding member is adjoined to the conveyance system at a predetermined interval from a third substrate holding member, the predetermined interval being based on one of post-curing time, conveyance speed, substrate thickness and temperature.

B36. The apparatus recited in claim B1, wherein a magnitude of the second preset orientation is based holding the second substrate in the second substrate holding member.

B37. The apparatus recited in claim B1, wherein a magnitude of the second preset orientation is based on one of substrate throughput, conveyance system length and conveyance speed.

B38. The apparatus recited in claim B1 above further comprises:
an enclosure cave, wherein the enclosure cave at least partially encloses the second substrate holding member being conveyed in the second predetermined direction.

B39. The apparatus recited in claim B1 above, wherein the second substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B40. The apparatus recited in claim B1 above, wherein the second substrate is a graphic media including at least one graphics image.

B41. The apparatus recited in claim B40 above, wherein the second substrate is a graphic media is a printable media and the laminate layer is applied to one of the printable media, graphics image, and printable media and graphics image.

B42. The apparatus recited in claim B38 further comprises:
an air circulator for circulating air throughout the enclosure cave.

B43. The apparatus recited in claim B1 above, wherein the second substrate is preprocessed with an ink-receptive coating.

B44. The apparatus recited in claim B43 above, wherein the second substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B45. The apparatus recited in claim B1 above, wherein a third substrate holding member is configured in a third preset orientation, the third preset orientation askew to the second predetermined direction.

B46. The apparatus recited in claim B1 above, wherein the second conveyance portion continues in the second predetermined direction for a second predetermined distance.

B47. The apparatus recited in claim B46 above, wherein the second predetermined distance is based on an amount of time for the curable liquid to pre-cure.

B48. The apparatus recited in claim B47 above, wherein the amount of time is based on the temperature of the second substrate.

B49. The apparatus recited in claim B1 further comprises:
a downloader for downloading a post-cured substrate.

B50. The apparatus recited in claim B1, wherein the second conveyance portion is substantially linear.

B51. The apparatus recited in claim B50, wherein the conveyance system is substantially horizontal and the second conveyance portion is substantially linear.

B52. The apparatus recited in claim B50, wherein the second predetermined orientation is near vertical.

B53. The apparatus recited in claim B50, wherein the conveyance system is substantially vertical and the second conveyance portion is substantially linear.

B54. The apparatus recited in claim B50, wherein the predetermined orientation is perpendicular to near vertical.

B55. The apparatus recited in claim B1, wherein the second substrate is positioned on the forward facing side of the second substrate holding member.

B56. The apparatus recited in claim B50, wherein the conveyance system is substantially horizontal and the second conveyance portion is substantially horizontal.

B57. The apparatus recited in claim B50, wherein the conveyance system is substantially vertical and the second conveyance portion is substantially vertical.

B58. The dynamic curing apparatus recited in claim B1 above, wherein one substrate holding member is substantially parallel with a preceding substrate holding member while the pair of substrate holding members are being conveyed on the first conveyance portion in the first direction.

B59. The dynamic curing apparatus recited in claim B1 above, wherein one substrate holding member is substantially parallel with a preceding substrate holding member while the pair of substrate holding members are being conveyed on the second conveyance portion in the second direction.

B60. The dynamic curing apparatus recited in claim B1 above, wherein the first direction is substantially opposite to the second direction.

B61. The apparatus recited in claim B1 further comprising:
a curing source for emitting energy rays, wherein the energy rays are simultaneously directed toward the curable liquid on a first surface of a third substrate held in a third substrate holding member and toward a second surface of a forth substrate held in a forth substrate holding member, wherein the conveyance system is configured with a third conveyance portion, the third conveyance portion being a curvilinear conveyance portion, wherein a third substrate holding member holds the third substrate being conveyed on the third conveyance portion in a third direction during which the curable liquid applied to a surface of the third substrate is cured.

B62. The dynamic curing apparatus recited in claim B61 above, wherein the energy rays are simultaneously directed toward the curable liquid on a first surface of a third substrate held in the third substrate holding member and toward a second surface located on an opposite side of the third substrate.

B63. The dynamic curing apparatus recited in claim B61 above, wherein the curing source emits energy in the form of one of ultraviolet (UV), infrared (IR), electron (E−) beam and microwave.

B64. The dynamic curing apparatus recited in claim B61 above, wherein the curing source for emitting energy rays is configurable for directing energy rays in a second direction.

B65. The dynamic curing apparatus recited in claim B61 above, wherein the energy rays are directed toward one of the third and forth substrate holding members, thereby curing residue of the curable liquid contaminating the one of the third and forth substrate holding members.

B66. The dynamic curing apparatus recited in claim B61 above, wherein the third substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B67. The dynamic curing apparatus recited in claim B61 above, wherein the third substrate is a graphic media including at least one graphics image.

B68. The dynamic curing apparatus recited in claim B67 above, wherein the third substrate is a graphic media is a printable media and the laminate layer is applied to one of the printable media, graphics image, and printable media and graphics image.

B69. The dynamic curing apparatus recited in claim B68 above, wherein the energy curable liquid laminate is curable by exposure to ultraviolet energy.

B70. The dynamic curing apparatus recited in claim B69 above, wherein the third substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B71. The dynamic curing apparatus recited in claim B61 above, wherein the curable liquid is applied to a surface of a substrate at a depth in excess of twenty thousandths of an inch (20.0 mils.).

B72. The dynamic curing apparatus recited in claim B61 above, wherein the curable liquid is applied to a surface of a substrate at a depth in excess of twenty-five thousandths of an inch (25.0 mils.).

B73. The dynamic curing apparatus recited in claim B61 above, wherein the curable liquid is applied to a surface of a substrate at a depth in excess of thirty thousandths of an inch (30.0 mils.).

B74. The dynamic curing apparatus recited in claim B61 above, wherein the curable liquid is applied to a surface of a substrate at a depth in excess of thirty-five thousandths of an inch (35.0 mils.).

B75. The dynamic curing apparatus recited in claim B61 above, wherein the third substrate is preprocessed with an ink-receptive coating.

B76. The dynamic curing apparatus recited in claim B75 above, wherein the third substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

B77. The dynamic curing apparatus recited in claim B61 above, wherein a substrate holding member maintains the preset orientation relative to the curvilinear direction as the substrate holding member is conveyed across the curvilinear conveyance portion.

B78. The dynamic curing apparatus recited in claim B61 above, wherein a substrate is transferred from one substrate holding member to a preceding substrate holding member as the substrate holding member and preceding substrate holding member are conveyed across the curvilinear conveyance portion.

B79. The dynamic curing apparatus recited in claim B61 above, wherein a substrate is transferred from a forward facing side of one substrate holding member to a rear facing side of a preceding substrate holding member as the substrate is conveyed across the curvilinear conveyance portion.

B80. The dynamic curing apparatus recited in claim B61 above, wherein the conveyance system is configured in a loop with the first conveyance portion above the second conveyance portion and the third conveyance portion being the curvilinear conveyance portion connecting to the first conveyance portion and the second conveyance portion.

B81. The dynamic curing apparatus recited in claim B61 above, wherein one substrate holding member is substantially parallel with a preceding substrate holding member prior to either of the pair of substrate holding members being conveyed across the curvilinear conveyance portion.

B82. The dynamic curing apparatus recited in claim B81 above, wherein one substrate holding member is askew from a preceding substrate holding member by a predetermined angle as the pair of substrate holding members are conveyed across the curvilinear conveyance portion.

B83. The dynamic curing apparatus recited in claim B81 above, wherein an amount of exposure to the energy rays emitted from the curing source by the curable liquid on a first surface is based on a value of the predetermined angle.

B84. The dynamic curing apparatus recited in claim B61 above, wherein the curing source further comprises:
an ultraviolet (UV) lamp having an arch length greater than a width of the third substrate.

B85. The dynamic curing apparatus recited in claim B61 above, wherein the curing source further comprises:
a plurality of ultraviolet (UV) lamps, wherein first energy rays emitted from a first lamp are directed askew from second energy rays emitted from a second lamp.

B86. The dynamic curing apparatus recited in claim B85 above, wherein the first energy rays emitted from the first lamp are directed toward the curable liquid on a front surface of the third substrate and second energy rays emitted from the second lamp are directed toward the rear surface of the forth substrate.

B87. The dynamic curing apparatus recited in claim B61 above, wherein the curing source is a lamp module comprising:
an ultraviolet (UV) lamp having an arch length greater than a width of the substrate;
a reflector; and
a cooling mechanism.

B88. The dynamic curing apparatus recited in claim B87 above, wherein the cooling mechanism transfers heat from the lamp module by a heat transfer medium, the heat transfer medium being one of air and water.

B89. The dynamic curing apparatus recited in claim B61 above, wherein the curvilinear conveyance portion of the conveyance system being substantially configured as an arc.

B90. The dynamic curing apparatus recited in claim B61 above further comprises:
an enclosure hood, wherein the enclosure hood at least partially encloses a substrate holding member being conveyed in the curvilinear direction.

C1. A dynamic curing apparatus for dynamically curing a curable liquid applied to a surface of a substrate comprising:
a conveyance system being configured with curvilinear conveyance portion;
a plurality of substrate holding members, each of said substrate holding members being adjoined to the conveyance system and conveyed across the curvilinear conveyance portion thereon in a curvilinear direction, wherein each of said substrate holding members is configured at a preset orientation relative to the curvilinear direction; and
a curing source for emitting energy rays, wherein the energy rays are simultaneously directed toward the curable liquid on a first surface of a first substrate held in a first substrate holding member and toward a second surface of a second substrate held in a second substrate holding member.

C2. The dynamic curing apparatus recited in claim C1 above, wherein the energy rays are simultaneously directed toward the curable liquid on the first surface of a first substrate held in the first substrate holding member and toward a second surface located on an opposite side of the first substrate.

C3. The dynamic curing apparatus recited in claim C1 above, wherein the curing source emits energy in the form of one of ultraviolet (UV), infrared (IR), electron (E−) beam and microwave.

C4. The dynamic curing apparatus recited in claim C1 above, wherein the curing source for emitting energy rays is configurable for directing energy rays in a second direction.

C5. The dynamic curing apparatus recited in claim C1 above, wherein the energy rays are directed toward one of the first and second substrate holding member, thereby curing residue of the curable liquid contaminating the one of the first and second substrate holding member.

C6. The dynamic curing apparatus recited in claim C1 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

C7. The dynamic curing apparatus recited in claim C1 above, wherein the substrate is a graphic media including at least one graphics image.

C8. The dynamic curing apparatus recited in claim C7 above, wherein the substrate is a graphic media is a printable media and the laminate layer is applied to one of the printable media, graphics image, and printable media and graphics image.

C9. The dynamic curing apparatus recited in claim C8 above, wherein the energy curable liquid laminate is curable by exposure to ultraviolet energy.

C10. The dynamic curing apparatus recited in claim C9 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

C11. The dynamic curing apparatus recited in claim C1 above, wherein the curable liquid applied to a surface of a substrate at a depth in excess of twenty thousandths of an inch (20.0 mils.).

C12. The dynamic curing apparatus recited in claim C1 above, wherein the curable liquid applied to a surface of a substrate at a depth in excess of twenty-five thousandths of an inch (25.0 mils.).

C13. The dynamic curing apparatus recited in claim C1 above, wherein the curable liquid applied to a surface of a substrate at a depth in excess of thirty thousandths of an inch (30.0 mils.).

C14. The dynamic curing apparatus recited in claim C1 above, wherein the curable liquid applied to a surface of a substrate at a depth in excess of thirty-five thousandths of an inch (35.0 mils.).

C15. The dynamic curing apparatus recited in claim C1 above, wherein the substrate is preprocessed with an ink-receptive coating.

C16. The dynamic curing apparatus recited in claim C15 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

C17. The dynamic curing apparatus recited in claim C1 above, wherein a substrate holding member maintains the preset orientation relative to the curvilinear direction as the substrate holding member is conveyed across the curvilinear conveyance portion.

C18. The dynamic curing apparatus recited in claim C1 above, wherein a substrate is transferred from one substrate holding member to a preceding substrate holding member as the substrate holding member and preceding substrate holding member are conveyed across the curvilinear conveyance portion.

C19. The dynamic curing apparatus recited in claim C1 above, wherein a substrate is transferred from a forward facing side of one substrate holding member to a rear facing side of a preceding substrate holding member as the substrate is conveyed across the curvilinear conveyance portion.

C20. The dynamic curing apparatus recited in claim C1 above, wherein a substrate falls from a forward facing side of one substrate holding member to a rear facing side of a preceding substrate holding member as the substrate is conveyed across the curvilinear conveyance portion.

C21. The dynamic curing apparatus recited in claim C1 above, wherein one substrate holding member is substantially parallel with a preceding substrate holding member prior to either of the pair of substrate holding members being conveyed across the curvilinear conveyance portion.

C22. The dynamic curing apparatus recited in claim C21 above, wherein one substrate holding member is askew from a preceding substrate holding member by a predetermined angle as the pair of substrate holding members are conveyed across the curvilinear conveyance portion.

C23. The dynamic curing apparatus recited in claim C21 above, wherein an amount of exposure to the energy rays emitted from the curing source by the curable liquid on a first surface is based on a value of the predetermined angle.

C24. The dynamic curing apparatus recited in claim C1 above, wherein the curing source further comprises:
an ultraviolet (UV) lamp having an arch length greater than a width of the substrate.

C25. The dynamic curing apparatus recited in claim C1 above, wherein the curing source further comprises:
a plurality of ultraviolet (UV) lamps, wherein first energy rays emitted from a first lamp are directed askew from second energy rays emitted from a second lamp.

C26. The dynamic curing apparatus recited in claim C25 above, wherein the first energy rays emitted from the first lamp are directed toward the curable liquid on a front surface of the first substrate and second energy rays emitted from the second lamp are directed toward the rear surface of the second substrate.

C27. The dynamic curing apparatus recited in claim C1 above, wherein the curing source is a lamp module comprising:
an ultraviolet (IV) lamp having an arch length greater than a width of the substrate;
a reflector; and
a cooling mechanism.

C28. The dynamic curing apparatus recited in claim C27 above, wherein the cooling mechanism transfers heat from the lamp module by a heat transfer medium, the heat transfer medium being one of air and water.

C29. The dynamic curing apparatus recited in claim C1 above, wherein the curvilinear conveyance portion of the conveyance system being substantially configured as an arc.

C30. The dynamic curing apparatus recited in claim C1 above further comprises:
an enclosure hood, wherein the enclosure hood at least partially encloses a substrate holding member being conveyed in the curvilinear direction.

D1. A method for pre-curing a curable liquid applied to a surface of a substrate, the method employing a pre-curing apparatus having a conveyance system and a plurality of substrate holding members, each of said plurality of substrate holding members being adjoined to the conveyance system and conveyed, the method comprising:
applying a curable liquid to a surface of a substrate;
receiving the substrate on a substrate holding member, wherein the substrate holding member is one of the plurality substrate holding members;
reorienting the substrate holding member to a predetermined orientation;
conveying the plurality substrate holding members on the conveyance system in a predetermined direction; and
pre-curing the curable liquid.

D2. The method for pre-curing a curable liquid recited in claim D1 further comprises:
wherein the predetermined orientation is between ninety-one degrees (91°) and one-hundred seventy-nine degrees (179°) to the predetermined direction.

D3. The method for pre-curing a curable liquid recited in claim D1, wherein the predetermined orientation is between ninety-one degrees (91°) and one-hundred thirty degrees (130°) to the predetermined direction.

D4. The method for pre-curing a curable liquid recited in claim D1, wherein the predetermined orientation is between one-hundred thirty degrees (130°) and one-hundred seventy-nine degrees (179°) to the predetermined direction.

D5. The method for pre-curing a curable liquid recited in claim D1, wherein the substrate is a first substrate and the substrate holding member is a first substrate holding member, the method further comprises:
applying a curable liquid to a surface of a second substrate;
receiving the second substrate on a second substrate holding member, wherein the second substrate holding member is another of the plurality substrate holding members and the second substrate holding member is adjoined to the conveyance system at a predetermined distance from the first substrate holding member, the predetermined distance being based on one of pre-curing time, conveyance speed, substrate thickness and the predetermined orientation;
reorienting the second substrate holding member to the predetermined orientation; and
pre-curing the curable liquid applied to the surface of the second substrate holding member.

D6. The method for pre-curing a curable liquid recited in claim D1, wherein a magnitude of the preset orientation is based on flowing the curable liquid across the surface of the substrate.

D7. The method for pre-curing a curable liquid recited in claim D1, wherein applying a curable liquid to a surface of a substrate further comprises:
screening the curable liquid laminate is applied to the surface of the substrate.

D8. The method for pre-curing a curable liquid recited in claim D1, wherein applying a curable liquid to a surface of a substrate further comprises:
jetting the curable liquid laminate is applied to the surface of the substrate.

D9. The method for pre-curing a curable liquid recited in claim D1, wherein applying a curable liquid to a surface of a substrate further comprises:
measuring the curable liquid laminate is applied to the surface of the substrate to a depth in excess of twenty thousandths of an inch (20.0 mils.).

D10. The method for pre-curing a curable liquid recited in claim D1, wherein applying a curable liquid to a surface of a substrate further comprises:
measuring the curable liquid laminate is applied to the surface of the substrate to a depth in excess of twenty-five thousandths of an inch (25.0 mils.).

D11. The method for pre-curing a curable liquid recited in claim D1 wherein applying a curable liquid to a surface of a substrate further comprises:
measuring the curable liquid laminate is applied to the surface of the substrate to a depth in excess of thirty thousandths of an inch (30.0 mils.).

D12. The method for pre-curing a curable liquid recited in claim D1, wherein applying a curable liquid to a surface of a substrate further comprises:
measuring the curable liquid laminate is applied to the surface of the substrate to a depth in excess of thirty-five thousandths of an inch (35.0 mils.).

D13. The method for pre-curing a curable liquid recited in claim D1, wherein applying a curable liquid to a surface of a substrate further comprises:
measuring the curable liquid laminate is applied to the surface of the substrate to a depth in excess of thirty-five thousandths of an inch (35.0 mils.).

D14. The method for pre-curing a curable liquid recited in claim D1, wherein prior to applying a curable liquid to a surface of a substrate the method further comprises:
combining silicon with the curable liquid.

D15. The method for pre-curing a curable liquid recited in claim D1 above, further comprises:
at least partially shielding a substrate holding member being conveyed in the predetermined direction from airborne particulate matter and latent ultraviolet radiation.

D16. The method for pre-curing a curable liquid recited in claim D1 above, wherein conveying the plurality substrate holding members on the conveyance system in a predetermined direction further comprises:
conveying the plurality substrate holding members in the predetermined direction for a predetermined distance.

D17. The method for pre-curing a curable liquid recited in claim D16 above, wherein the predetermined distance is based on an amount of time for the curable liquid to pre-cure on the surface of the substrate.

D18. The method for pre-curing a curable liquid recited in claim D17 above, wherein the amount of time is based on one of thickness of the curable liquid and the predetermined orientation of the surface of the substrate.

D19. The method for pre-curing a curable liquid recited in claim D1 further comprises:
containing residual curable liquid flowing from the surface of the substrate.

D20. The method for pre-curing a curable liquid recited in claim D1, wherein the predetermined direction is substantially linear.

D21. The method for pre-curing a curable liquid recited in claim D1, wherein the conveyance system is substantially horizontal, conveying the plurality substrate holding members on the conveyance system in a predetermined direction further comprises:
conveying the plurality substrate holding members in a substantially horizontal direction.

D22. The method for pre-curing a curable liquid recited in claim D21, wherein the predetermined orientation is near vertical.

D23. The method for pre-curing a curable liquid recited in claim D1, wherein the conveyance system is substantially vertical, conveying the plurality substrate holding members on the conveyance system in a predetermined direction further comprises:
conveying the plurality substrate holding members in a substantially vertical direction.

D24. The method for pre-curing a curable liquid recited in claim D23, wherein the predetermined orientation is near horizontal.

D24. The method for pre-curing a curable liquid recited in claim D1 further comprises:
curing the substrate;
applying a curable liquid to another surface of the substrate;
receiving the substrate on a substrate holding member, wherein the substrate holding member is one of the plurality substrate holding members;
reorienting the substrate holding member to a predetermined orientation;
conveying the plurality substrate holding members on the conveyance system in a predetermined direction; and
pre-curing the curable liquid on the other surface of the substrate.

D25. The method for pre-curing a curable liquid recited in claim D24 further comprises:
wherein the predetermined orientation is between ninety-one degrees (91°) and one-hundred seventy-nine degrees (179°) to the predetermined direction.

D26. The method for pre-curing a curable liquid recited in claim D24, wherein the predetermined orientation is between ninety-one degrees (91°) and one-hundred thirty degrees (130°) to the predetermined direction.

D27. The method for pre-curing a curable liquid recited in claim D24, wherein the predetermined orientation is between one-hundred thirty degrees (130°) and one-hundred seventy-nine degrees (179°) to the predetermined direction.

D28. The method for pre-curing a curable liquid recited in claim D24, wherein applying a curable liquid to a surface of a substrate further comprises:
screening the curable liquid laminate is applied to the surface of the substrate.

D29. The method for pre-curing a curable liquid recited in claim D24, wherein applying a curable liquid to a surface of a substrate further comprises:
jetting the curable liquid laminate is applied to the surface of the substrate.

D30. The method for pre-curing a curable liquid recited in claim D24, wherein applying a curable liquid to a surface of a substrate further comprises:
measuring the curable liquid laminate is applied to the surface of the substrate to a depth of less than twelve thousandths of an inch (12.0 mils.).

E1. A method for laminating a substrate with a curable liquid laminate applied to a surface of a substrate employing a wicket conveyor system, the wicket conveyor system being configured with a first conveyor portion for conveying in a first predetermined direction and configured with a second conveyor portion for conveying in a second predetermined direction and further with a third conveyor portion for conveying in a curvilinear direction between the first conveyor portion and the second conveyor portion and the wicket conveyor system further being configured with a plurality of wickets being adjoined to one of the first, second and third wicket conveyor portions, the method comprising:
applying a curable liquid laminate to a surface of a substrate;
receiving the substrate on to a wicket;
conveying the wicket on the first conveyor portion and in the first predetermined direction, wherein the curable liquid laminate is pre-cured along first predetermined direction.

E2. The method for laminating a substrate using a wicket conveyor system recited in claim E1 above further comprises:
conveying the wicket on the third conveyor portion and in the curvilinear direction, wherein the curable liquid laminate is cured along curvilinear direction.

E3. The method for laminating a substrate using a wicket conveyor system recited in claim E2 above further comprises:
conveying the wicket on the second conveyor portion and in the second predetermined direction, wherein the curable liquid laminate is post-cured along second predetermined direction.

F1. An automated method for created high gloss laminated substrate surface comprising:
metering a coating of an energy curable liquid laminate to a surface of a substrate, the coating being metered to a depth of greater than twelve thousandths of an inch (12.0 mils.);
transferring the coated substrate to one of a plurality of substrate holding members, each of the plurality of substrate holding members being adjoined to a conveyance system, wherein the one of a plurality of substrate holding members is conveyed in a predetermined direction; and
conveying the substrate having the energy curable liquid laminated surface on the conveyance system in a predetermined direction, wherein the one of a plurality of substrate holding members substrate holding member is configured for holding the liquid laminated substrate in a preset orientation, the preset orientation askew to the second predetermined direction.

F2. The method for pre-curing a curable liquid recited in claim F1 further comprises:
wherein the predetermined orientation is between ninety-one degrees (91°) and one-hundred seventy-nine degrees (179°) to the predetermined direction.

F3. The automated method for created high gloss laminated substrate surface recited in claim F1, wherein the predetermined orientation is between ninety-one degrees (91°) and one-hundred thirty degrees (130°) to the predetermined direction.

F4. The method for pre-curing a curable liquid recited in claim F1, wherein the predetermined orientation is between one-hundred thirty degrees (130°) and one-hundred seventy-nine degrees (179°) to the predetermined direction.

F5. The automated method for created high gloss laminated substrate surface recited in claim F1 further comprises:
curing the energy curable liquid laminate on the surface of the substrate.

F6. The automated method for created high gloss laminated substrate surface recited in claim F1, wherein a magnitude of the preset orientation is based on flowing the energy curable liquid laminate across the surface of the substrate.

F7. The automated method for created high gloss laminated substrate surface recited in claim F1, wherein metering a coating of an energy curable liquid laminate to a surface of a substrate further comprises:
screening the energy curable liquid laminate is applied to the surface of the substrate.

F8. The automated method for created high gloss laminated substrate surface recited in claim F1, wherein metering a coating of an energy curable liquid laminate to a surface of a substrate further comprises:
jetting the energy curable liquid laminate is applied to the surface of the substrate.

F9. The automated method for created high gloss laminated substrate surface recited in claim F1, wherein metering a coating of an energy curable liquid laminate to a surface of a substrate further comprises:
measuring the energy curable liquid laminate is applied to the surface of the substrate to a depth in excess of twenty thousandths of an inch (20.0 mils.).

F10. The automated method for created high gloss laminated substrate surface recited in claim F1, wherein metering a coating of an energy curable liquid laminate to a surface of a substrate further comprises:
measuring the energy curable liquid laminate is applied to the surface of the substrate to a depth in excess of twenty-five thousandths of an inch (25.0 mils.).

F11. The automated method for created high gloss laminated substrate surface recited in claim F1, wherein metering a coating of an energy curable liquid laminate to a surface of a substrate further comprises:
measuring the energy curable liquid laminate is applied to the surface of the substrate to a depth in excess of thirty thousandths of an inch (30.0 mils.).

F12. The automated method for created high gloss laminated substrate surface recited in claim F1, wherein metering a coating of an energy curable liquid laminate to a surface of a substrate further comprises:
measuring the energy curable liquid laminate is applied to the surface of the substrate to a depth in excess of thirty-five thousandths of an inch (35.0 mils.).

F13. The automated method for created high gloss laminated substrate surface recited in claim F1, wherein metering a coating of an energy curable liquid laminate to a surface of a substrate further comprises:
measuring the energy curable liquid laminate is applied to the surface of the substrate to a depth in excess of thirty-five thousandths of an inch (35.0 mils.).

F14. The automated method for created high gloss laminated substrate surface recited in claim F1, wherein prior to metering the coating of an energy curable liquid laminate to a surface of a substrate further comprises: the method further comprises:
combining silicon with the curable liquid.

F15. The automated method for created high gloss laminated substrate surface recited in claim F1 above, further comprises:
curing the substrate; and
downloading the substrate from the conveyance system.

F16. The automated method for created high gloss laminated substrate surface recited in claim F1 above, wherein conveying the substrate having the energy curable liquid laminated surface on the conveyance system in a predetermined direction, further comprises:
conveying the plurality substrate holding members in the predetermined direction for a predetermined distance.

F17. The automated method for created high gloss laminated substrate surface recited in claim F16 above, wherein the predetermined distance is based on an amount of time for the energy curable liquid laminate to pre-cure on the surface of the substrate.

F18. The automated method for created high gloss laminated substrate surface recited in claim F17 above, wherein the amount of time is based on one of thickness of the energy curable liquid laminate and the predetermined orientation of the surface of the substrate.

F19. The automated method for created high gloss laminated substrate surface recited in claim F1 further comprises:
containing residual energy curable liquid laminate flowing from the surface of the substrate.

F20. The automated method for created high gloss laminated substrate surface recited in claim F1, wherein the predetermined direction is substantially linear.

F21. The automated method for created high gloss laminated substrate surface recited in claim F1, wherein the conveyance system is substantially horizontal, conveying the plurality substrate holding members on the conveyance system in a predetermined direction further comprises:
conveying the plurality substrate holding members in a substantially horizontal direction.

F22. The automated method for created high gloss laminated substrate surface recited in claim F21, wherein the predetermined orientation is near vertical.

F23. The automated method for created high gloss laminated substrate surface recited in claim F1, wherein the conveyance system is substantially vertical, conveying the plurality substrate holding members on the conveyance system in a predetermined direction further comprises:
conveying the plurality substrate holding members in a substantially vertical direction.

F24. The automated method for created high gloss laminated substrate surface recited in claim F23, wherein the predetermined orientation is near horizontal.

F24. The automated method for created high gloss laminated substrate surface recited in claim F1 further comprises:
curing the substrate;
metering a coating of an energy curable liquid laminate to another surface of the substrate, the coating being metered to a depth of less than twelve thousandths of an inch (12.0 mils.);
transferring the other coated substrate to one of a plurality of substrate holding members, each of the plurality of substrate holding members being adjoined to a conveyance system, wherein the one of a plurality of substrate holding members is conveyed in a predetermined direction; and
conveying the other substrate having the energy curable liquid laminated surface on the conveyance system in a predetermined direction, wherein the one of a plurality of substrate holding members substrate holding member is configured for holding the liquid laminated substrate in a preset orientation, the preset orientation askew to the second predetermined direction.

F25. The automated method for created high gloss laminated substrate surface recited in claim F24 further comprises:
wherein the predetermined orientation is between ninety-one degrees (91°) and one-hundred seventy-nine degrees (179°) to the predetermined direction.

F26. The automated method for created high gloss laminated substrate surface recited in claim F24, wherein the predetermined orientation is between ninety-one degrees (91°) and one-hundred thirty degrees (130°) to the predetermined direction.

F27. The automated method for created high gloss laminated substrate surface recited in claim F24, wherein the predetermined orientation is between one-hundred thirty degrees (130°) and one-hundred seventy-nine degrees (179°) to the predetermined direction.

F28. The automated method for created high gloss laminated substrate surface recited in claim F24, wherein applying a curable liquid to a surface of a substrate further comprises:
screening the energy curable liquid laminate is applied to the surface of the substrate.

F29. The automated method for created high gloss laminated substrate surface recited in claim F24, wherein applying a curable liquid to a surface of a substrate further comprises:
jetting the energy curable liquid laminate is applied to the surface of the substrate.

F30. The automated method for created high gloss laminated substrate surface recited in claim F24 further comprising:
curing the energy curable liquid laminate on the surface of the other substrate.

G1. A laminated product formed using a sheet flow lamination process comprising coating a surface with an energy curable liquid laminate, orienting the coated surface such that the coated surface is at an angle greater than forty-five degrees (45°) from horizontal thereby flowing the energy curable liquid laminate across the surface and curing the liquid laminate, the laminated product comprising:
a substrate; and
a laminate layer formed from the energy curable liquid laminate, wherein the laminate layer has a depth in excess of twelve thousandths of an inch (12.0 mils.) and further wherein a surface of the laminate layer has a gloss level in excess of ninety-seven (97.0) gloss units measured at sixty degrees (60°).

G2. The laminated product recited in claim G1 above, wherein the energy curable liquid laminate is curable by exposure to ultraviolet energy.

G3. The laminated product recited in claim G1 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

G4. The laminated product recited in claim G1 above, wherein the substrate is a graphic media including at least one graphics image.

G5. The laminated product recited in claim G4 above, wherein the substrate is a graphic media is a printable media and the laminate layer is applied to one of the printable media, graphics image, and printable media and graphics image.

G6. The laminated product recited in claim G5 above, wherein the energy curable liquid laminate is curable by exposure to ultraviolet energy.

G7. The laminated product recited in claim G6 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

G8. The laminated product recited in claim G6 above, wherein the energy curable liquid laminate is applied to a surface of the substrate using one of screen application, jet application and roller application.

G9. The laminated product recited in claim G1 above, wherein the laminate layer has a depth in excess of twenty thousandths of an inch (20.0 mils.).

G10. The laminated product recited in claim G1 above, wherein the laminate layer has a depth in excess of twenty-five thousandths of an inch (25.0 mils.).

G11. The laminated product recited in claim G1 above, wherein the laminate layer has a depth in excess of thirty thousandths of an inch (30.0 mils.).

G12. The laminated product recited in claim G1 above, wherein the laminate layer has a depth in excess of thirty-five thousandths of an inch (35.0 mils.).

G13. The laminated product recited in claim G1 above, wherein the surface of the laminate layer has a gloss level in excess of one hundred (100.0) gloss units measured at sixty degrees (60°).

G14. The laminated product recited in claim G1 above, wherein the surface of the laminate layer has a gloss level in excess of one hundred five (105.0) gloss units measured at sixty degrees (60°).

G15. The laminated product recited in claim G1 above, wherein the surface of the laminate layer has a gloss level in excess of one hundred ten (110.0) gloss units measured at sixty degrees (60°).

G16. The laminated product recited in claim G1 above, wherein the surface of the laminate layer has a gloss level in excess of one hundred fifteen (115.0) gloss units measured at sixty degrees (60°).

G17. The laminated product recited in claim G1 above, wherein the laminate layer further includes silicon added to the energy curable liquid laminate prior to curing the energy curable liquid laminate.

G18. The laminated product recited in claim G1 above, wherein the substrate is preprocessed with an ink-receptive coating.

G19. The laminated product recited in claim G18 above, wherein the substrate is one of cellulose-based pulp paper, cotton-based pulp paper, cardboard, matte, polyethylene (polythene), cast polypropylene, oriented polypropylene, cellophane, co-extrusions polyvinylchlorid, laminated substrates, metallised film and polyester.

G20. The laminated product recited in claim G1 above, wherein the surface of the substrate laminated using the sheet flow lamination process has a gloss level value at least five (5.0) gloss units higher than an identical substrate laminated with an identical energy curable liquid laminate not using the sheet flow lamination process.
